(19) United States
(12) Patent Application Publication
(10) Pub. No.: US 2007/0218989 A1
(43) Pub. Date: Sep. 20, 2007

(54) Gaming machine, service providing system and server

(75) Inventor: Kazuo Okada, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: ARUZE CORP., Tokyo (JP)

(21) Appl. No.: 11/374,476

(22) Filed: Mar. 14, 2006

(51) Int. Cl. A63F 13/00

(52) U.S. Cl. 463/31

(57) ABSTRACT

A gaming machine of the present invention comprises: display means capable of displaying images; storage means for storing plural types of reach effect images to be displayed during reach, as image data representing images to be displayed on the display means; and display control means for displaying reach effect images on the display means, on the basis of image data selected from the image data stored in the storage means, wherein the display control means, when displaying specific reach effect images on the basis of image data having a lower probability of being selected out of the plural types of image data stored in the storage means, displays an output information image including predetermined output information on the display means in such a manner that the output information image can be captured from the outside by image pickup means.

### CROSS-REFERENCE TO RELATED APPLICATIONS

The present application relates to Japanese Patent Application No. 2004-373956, filed on Dec. 24, 2004. The contents of this application are incorporated herein by reference in their entirety.

### BACKGROUND OF THE INVENTION

1. Field of the Invention

The present invention relates to a gaming machine such as a pachinko gaming machine, a service providing system comprising the gaming machine and a server, and a server.

2. Discussion of the Background

In a pachinko gaming machine, gaming balls are launched onto a gaming board by a player's operation of a launching handle and, gaming balls launched onto the gaming board are then flowed downwardly on the gaming board while colliding against nails and the like to change the direction of movement thereof. Then, in the event that gaming balls enter a starting opening provided on the gaming board, internal lottery is performed for determining whether or not a big hit should be generated, and if a big hit is generated as a result of the internal lottery, a predetermined combination of plural special symbols (for example, “7”-“7”-“7”) is stopped and displayed on a display device such as an LCD and, subsequently, a special game state is generated. A game in the special game state is generally the game in which a single game regarded as 1 round can be played up to 10 rounds, wherein the single game is from the time a special winning opening provided in the gaming board is brought into an open state to the time when ten gaming balls have entered the special winning opening or when a predetermined time has elapsed. Every time a gaming ball enters the special winning opening, a predetermined number of gaming balls are disbursed, which allows the player to acquire a great number of gaming balls in the special game state. In such a pachinko gaming machine, generally, in the event that the display state of special symbols becomes reach (one more to win), the variable display of remaining special symbols is changed to a different state from usual and also effect images are changed to reach effect images, which allows the player to have sense of expectancy and immediacy.

However, such internal lottery is independently performed by a computer in each game and, previous results are not reflected on the probability of the occurrence of a big hit. Therefore, in some cases, only reach may frequently be generated and no big hit may be generated for a long time (so-called “hamari” state) and, as a result, no special game state can be generated for a long time. In such cases, even when various reach effect images are displayed and ingenious effects are performed, the player can not enjoy himself and has complaints. Therefore, there is a need for providing a new service which can cast aside the player's dissatisfaction and uncomfortable feeling.

As a conventional pachinko gaming machine, for example, There have been a pachinko gaming machine in which two-dimensional codes including game information and the like are displayed on a display device such as an LCD, thereby enabling players to capture the two-dimensional codes through a portable telephone and the like for acquiring game information (for example, see JP-A 2004-236902).

With the pachinko gaming machine described in JP-A 2004-236902, it is possible to offer pleasure of acquisition of game information from pachinko gaming machine with the use of a portable telephone, in addition to pleasure of games and pleasure of effects.

However, with the pachinko gaming machine described in JP-A 2004-236902, only a two-dimensional code is displayed in the event of the occurrence of a big hit and, therefore, pleasure and satisfaction which a player can obtain by the displayed two-dimensional code reduce by half.

Since the player's pleasure and satisfaction may vary depending on the timing when two-dimensional codes are displayed, the timing of displaying of two-dimensional codes is significantly important. Therefore, the pachinko gaming machine described in JP-A 2004-236902 has left much to be improved.

The contents of JP-A 2004-236902 are incorporated herein by reference in their entirety.

### SUMMARY OF THE INVENTION

The present invention has been made in view of the aforementioned problems and aims at providing a gaming machine, a service supply system and a server which can increase pleasure and satisfaction which a player can obtain by displaying output information images such as two-dimensional codes.

In order to attain the aforementioned object, the present invention provides the following configuration.

(1) A gaming machine comprising:

display means capable of displaying images;

storage means for storing plural types of reach effect images to be displayed during reach, as image data representing images to be displayed on the display means; and

display control means for displaying reach effect images on the display means, on the basis of image data selected from the image data stored in the storage means,

wherein

the display control means, on the occasion of display specific reach effect images on the basis of image data having a lower probability of being selected out of the plural types of image data stored in the storage means, displays an output information image including predetermined output information on the display means, in such a manner that the output information image can be captured from the outside by image pickup means.

With the configuration (1), on the occasion when a specific reach image (for example, a reach image to be displayed during so-called super reach, a reach image to be displayed during premium reach, and the like) is displayed, an output information image (for example, a two-dimensional code such as a QR code (registered trademark)) including predetermined output information is displayed. Further, a player is enabled to capture the output information image with image pickup means (for example, a CCD camera) of a portable telephone or the like to acquire the output information. Further, it is also possible to provide the following service. That is, when the output information is transmitted from the portable telephone or the like to a server or the like, information (for example, image data for waiting images, music data for cellular phone ring melodies and the like) associated with the output information is transmitted from the server or the like to the portable telephone.

As described above, with the configuration (1), on the occasion when a specific reach image based on image data having a lower probability of being selected is displayed, output information can be acquired. Therefore, in the event of the occurrence of specific reach during which a specific reach image is displayed, namely in the event of the occurrence of specific reach in a normal game state prior to the transition to the special game state, output information can be acquired, and thereby the player's pleasure and satisfaction can be further enhanced. Further, under the condition where a specific reach image is less likely to be displayed, the player can see the specific reach image being displayed, further an output information image is displayed, and the player can acquire output information from the output information image; therefore the player's pleasure and satisfaction can be further enhanced.

The present invention also provides the following configuration.

(2) The gaming machine according to the configuration (1),

wherein

the output information image is included in a specific reach image.

With the configuration (2), when a specific reach image is displayed, an output information image is also displayed along therewith. Therefore the player can immediately acquire output information in the event that the specific reach image is displayed, thereby immediate satisfaction can be offered.

The present invention also provides the following configuration.

(3) A service providing system comprising:

the gaming machine according to the configuration (1) or (2); and

a server capable of transmitting and receiving data to and from a portable terminal device including the image pickup means through a communication line,

wherein

the server includes:

information storage means for storing plural types of information to be transmitted to the portable terminal device, in association with respective output information;

extraction means for extracting information associated with output information from the information storage means, on receiving this output information from the portable terminal device which generates the output information on the basis of image data resulted from capturing of an output information image displayed on the display means with the image pickup means; and

transmission means for transmitting the information extracted by the extraction means to the portable terminal device, through the communication line.

With the configuration (3), on the occasion when a specific reach image is displayed, an output information image is displayed in the gaming machine and, the player can capture the output information image through the image pickup means of the portable terminal device and can transmit output information, which is generated from the output information image in the portable terminal device, to the server for acquiring information associated with the output information, such as image data for waiting images, music data for cellular phone ring melodies and the like. Therefore, in the event of the occurrence of specific reach during which a specific reach image is displayed, namely in the event of the occurrence of specific reach in a normal game state prior to the transition to the special game state, output information can be acquired, which can further enhance the player's pleasure and satisfaction. Further, under the condition where a specific reach image is less likely to be displayed, the player can see the specific reach image being displayed, further an output information image is displayed, and the player can acquire output information from the output information image, which can further enhance the player's pleasure and satisfaction.

The present invention also provides the following configuration.

(4) A server capable of transmitting and receiving data to and from a portable terminal device including image pickup means capable of capturing output information images displayed on the display means included in the gaming machine according to the configuration (1) or (2), through a communication line,

the server comprising:

information storage means for storing plural types of information to be transmitted to the portable terminal device, in association with respective output information;

extraction means for extracting information associated with output information from the information storage means, on receiving this output information from the portable terminal device which generates the output information on the basis of image data resulted from capturing of an output information image displayed on the display means with the image pickup means; and

transmission means for transmitting the information extracted by the extraction means to the portable terminal device, through the communication line.

With the configuration (4), output information can be received from the portable terminal device and information associated with the output information can be transmitted to the portable terminal device, wherein the output information is generated on the basis of image data resulted from capturing of an output information image from the gaming machine with the image pickup means of the portable terminal device. Therefore, in the event of the occurrence of specific reach during which a specific reach image is displayed, namely in the event of the occurrence of specific reach in a normal game state prior to the transition to the special game state, output information can be acquired, which can further enhance the player's pleasure and satisfaction. Further, under the condition where a specific reach image is less likely to be displayed, the player can see the specific reach image being displayed, further an output information image is displayed, and the player can acquire output information from the output information image, which can further enhance the player's pleasure and satisfaction.

With the present invention, on the occasion when a specific reach image is displayed, output image information is displayed, which can enhance the player's pleasure and satisfaction. For example, in the case where a reach image is displayed only during a normal game state prior to the special game state (big hit), an output information image is displayed prior to the occurrence of the special game state, which can further enhance the player's pleasure and satisfaction.

### BRIEF DESCRIPTION OF THE DRAWINGS

FIG. 1 is a network structural view illustrating a service providing system according to an embodiment of the present invention;

FIG. 2 is a perspective view schematically illustrating the pachinko gaming machine illustrated in FIG. 1;

FIG. 3 is an exploded perspective view schematically illustrating the pachinko gaming machine illustrated in FIG. 1;

FIG. 4 is a front view of the electric decoration unit included in the pachinko gaming machine illustrated in FIG. 1;

FIG. 5 is a front view schematically illustrating the pachinko gaming machine illustrated in FIG. 1;

FIG. 6 is an explanation view illustrating a display screen being displayed on the pachinko gaming machine illustrated in FIG. 1;

FIG. 7 is a block diagram illustrating the main control circuit and the sub control circuit structured in the pachinko gaming machine illustrated in FIG. 1;

FIG. 8 is a flowchart illustrating a main process conducted in the main control circuit;

FIG. 9 is a flowchart illustrating a system timer interruption process conducted in the main control circuit;

FIG. 10 is a flowchart illustrating the subroutine of a special symbol control process which is called up and conducted in step S15 in the process illustrated in FIG. 8;

FIG. 11 is an explanation view illustrating state transitions during special symbol control process illustrated in FIG. 10;

FIG. 12 is a flowchart illustrating the subroutine of a special symbol storage check process which is called up and conducted in step S72 in the subroutine illustrated in FIG. 10;

FIG. 13 is a view illustrating an exemplary reach variation pattern determination table;

FIG. 14 is a flowchart illustrating the subroutine of an input detection process which is called up and conducted in step S43 in the process illustrated in FIG. 9;

FIG. 15 is a flowchart illustrating the subroutine of a special symbol-related switch input process which is called up and conducted in step S232 in the subroutine illustrated in FIG. 14;

FIG. 16 is a flowchart illustrating the subroutine of the starting opening detection process which is called up and conducted in step S266 in the subroutine illustrated in FIG. 15;

FIG. 17 is a flowchart illustrating the subroutine of a command reception process which is conducted in the sub control circuit;

FIG. 18 is a view illustrating an exemplary output information table;

FIG. 19 is a flowchart illustrating the subroutine of an encoding process which is called up and conducted in step S286 in the subroutine illustrated in FIG. 17;

FIG. 20 is a flowchart illustrating a display control process conducted in the display control circuit;

FIG. 21 is a block diagram illustrating the internal structure of the portable telephone illustrated in FIG. 1;

FIG. 22 is a block diagram illustrating the internal structure of the server illustrated in FIG. 1;

FIG. 23 is a flowchart illustrating processes conducted between the portable telephone and the server;

FIG. 24 is an exemplary premium data table;

FIG. 25 is a flowchart illustrating the subroutine of a two-dimensional code recognition process which is called up and conducted in step S502 in the process illustrated in FIG. 23; and

FIG. 26 is a view illustrating an exemplary waiting image which is transmitted, as a premium, from the server to the portable telephone.

### DESCRIPTION OF THE EMBODIMENTS

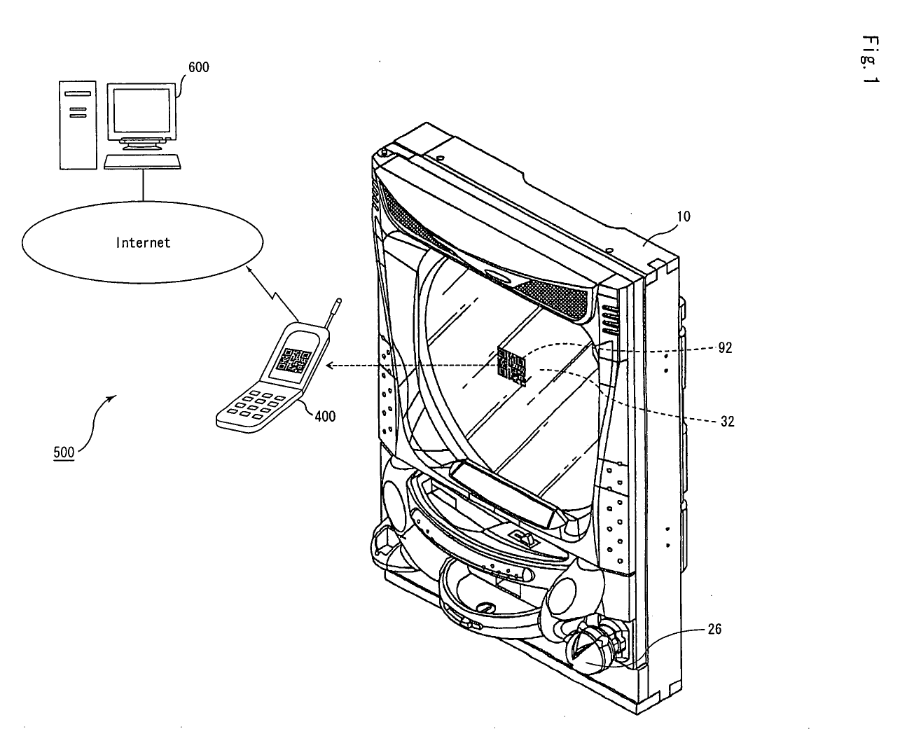

FIG. 1 is a network structural view illustrating a service providing system according to an embodiment of the present invention.

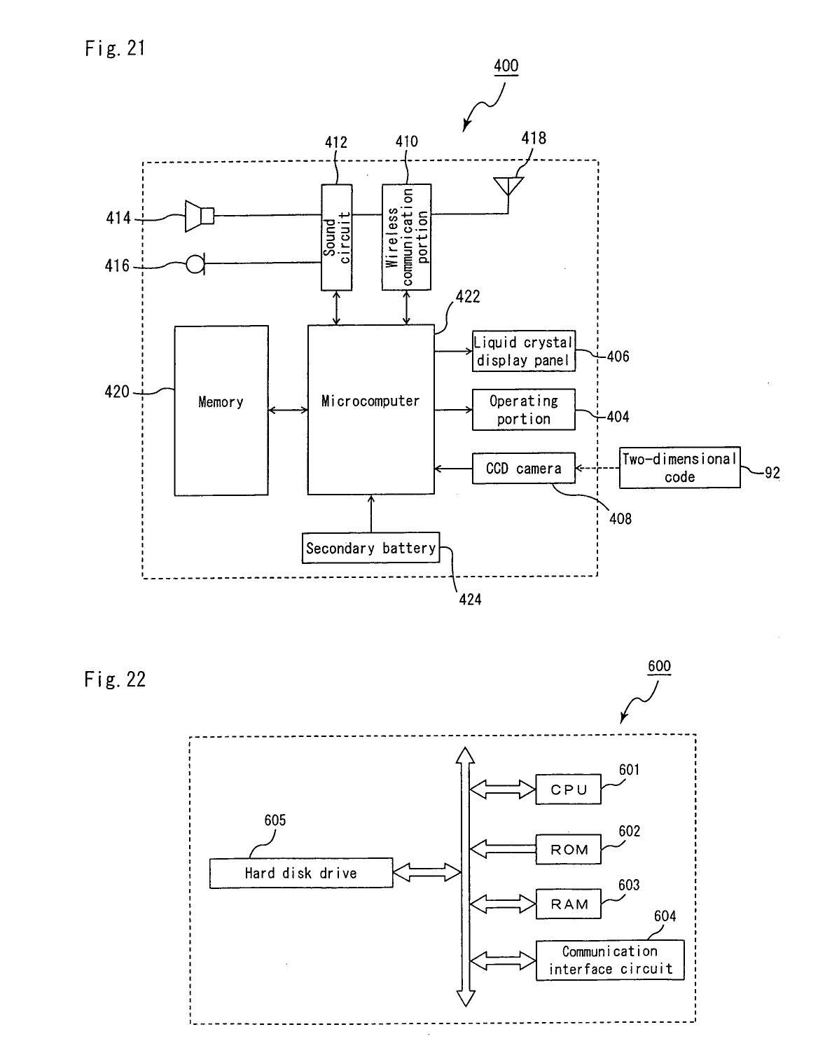

The service providing system 500 includes a pachinko gaming machine 10 and a server 600 capable of wirelessly transmitting and receiving data, via the Internet, to and from a portable telephone 400 equipped with a CCD camera 408 (not shown, see FIG. 21) as image pickup means.

In the pachinko gaming machine 10, in the event of the occurrence of reach, normal reach or super reach occurs. The “normal reach” is reach having a relatively low probability of subsequently generating a special game state while the “super reach” is reach having a relatively high probability of subsequently generating a special game state. A liquid crystal display device 32 displays an image (not shown) indicative of whether reach occurred in the pachinko gaming machine 10 is normal reach or super reach. The liquid crystal display device 32 corresponds to display means.

Further, the liquid crystal display device 32 displays an effect image which is a reach image during reach, while the liquid crystal display device 32 displays an effect image which corresponds to a specific reach image during super reach.

When a specific reach image is displayed on the liquid crystal display device 32 in the pachinko gaming machine 10, a two-dimensional code 92 which is provided by coding predetermined output information is displayed on the liquid crystal display device 32. A player can capture the two-dimensional code 92 with the CCD camera 408 included in the portable telephone 400. In the present embodiment, there will be described a case where such output information is an URL indicative of a predetermined address in the server 600 in the Internet (for example, an address of a website of the gaming machine maker). However, such output information is not limited to the aforementioned case, in the present invention.

The portable telephone 400 recognizes the two-dimensional code from image data acquired by capturing the two-dimensional code 92 with the CCD camera 408 and then generates output information from the recognized two-dimensional code. Then, the portable telephone 400 transmits the output information to the server 600.

A hard disk drive 605 (not shown) included in the server 600 stores plural types of premium data (for example, image data for waiting images, music data for cellular phone ring melodies and the like) in association with output information. Herein, the premium data is information stored in the server 600 and also is information to be transmitted to the portable telephone 400. The server 600 extracts the premium data on the basis of the output information received from the portable telephone 400 and transmits the premium data to the portable telephone 400.

As described above, with the service providing system 500, the player can capture, using the CCD camera 408 included in the portable telephone 400, the two-dimensional code 92 displayed along with a specific reach image on the liquid crystal display device 32 of the pachinko gaming machine 10 to acquire the output information through the portable telephone 400 and also can transmit the output information to the server 600 to acquire the premium data associated with the output information from the server 600.

The pachinko gaming machine 10 of the service supply system 500 corresponds to a gaming machine according to the present invention. The gaming machine according to the present invention is not limited to the aforementioned example and may be, for example, a pachi-slot gaming machine, a slot machine and the like.

While, in the present embodiment, there will be described a case where a two-dimensional code is used as an output information image, the output information image according to the present invention is not limited to a two-dimensional code and may also include an one-dimensional code (a bar code). Further, while, in the present embodiment, there will be described a case where a QR code (registered trademark) is employed as the two-dimensional code, the present invention is not limited to the case.

The portable telephone 400 corresponds to a portable terminal device according to the present invention. Herein, the portable terminal device according to the present invention is not particularly limited and may be any portable terminal device including image pickup means and also being capable of transmitting and receiving data to and from the server through a communication line. For example, the portable terminal device may be a personal digital assistance, a dedicated portable terminal device for the aforementioned service providing system or the like.

Further, while, in the present embodiment, there will be described a case where the portable telephone 400 and the server 600 transmit and receive data to and from each other in a wireless manner, the present invention is not limited to the case and they may transmit and receive data to and from each other through wire communication. Namely, the communication line according to the present invention includes a wire communication path and a wireless communication path.

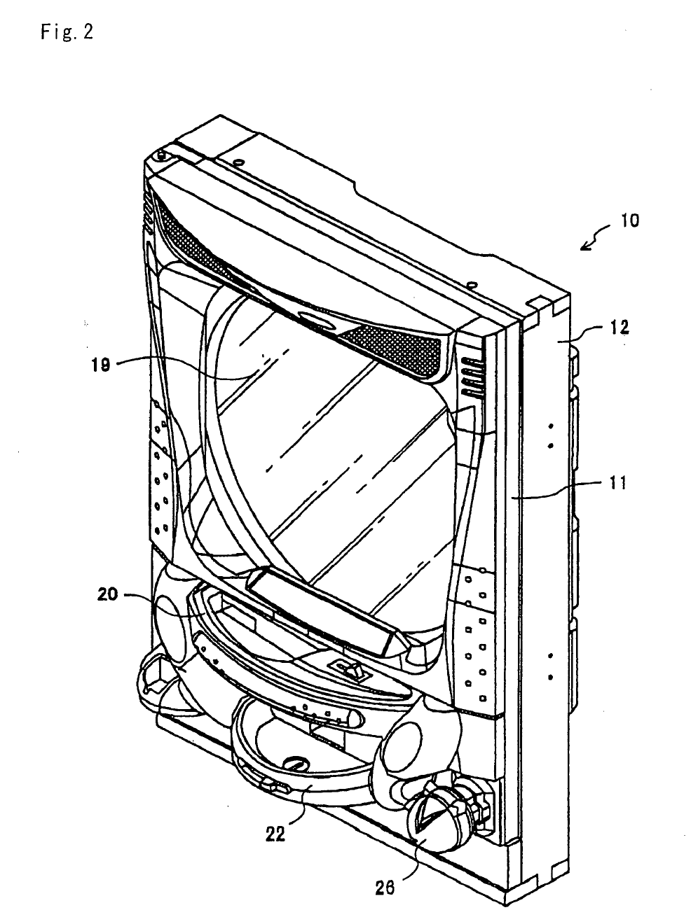

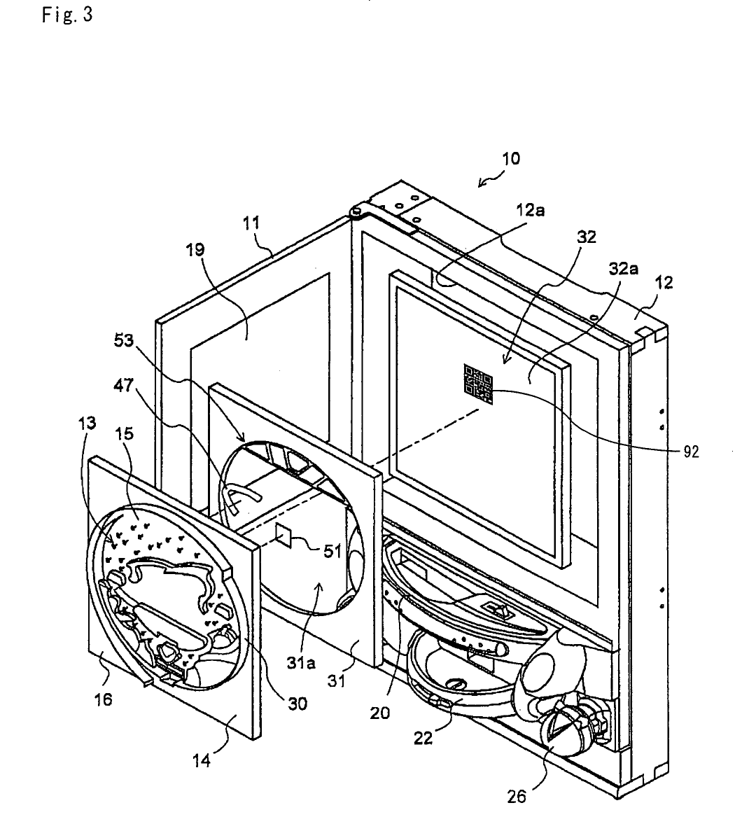

FIG. 2 is a perspective view schematically illustrating the pachinko gaming machine illustrated in FIG. 1. FIG. 3 is an exploded perspective view schematically illustrating the pachinko gaming machine illustrated in FIG. 1.

As illustrated in FIG. 2 and FIG. 3, the pachinko gaming machine 10 is constituted by a main body frame 12 having an opening 12a formed through its front surface, various types of components placed within the opening 12a of the main body frame 12, and a door 11 pivotally and openably mounted to the main body frame 12 at the front side thereof. As illustrated in FIG. 2, the door 11 is for closing the opening 12a at the front side thereof and is usually kept closed during games. Further, there are placed an upper plate 20, a lower plate 22, a launching handle 26 and the like, on the front surface of the main body frame 12.

As will be described later, there are placed, within the opening 12a of the main body frame 12, the liquid crystal display device 32 for displaying effect images, a spacer 31, a gaming board 14 and the like. Further, for ease of understanding, description of various types of components (not shown) other than the gaming board 14, the spacer 31 and the liquid crystal display device 32 will be omitted.

The gaming board 14 is entirely formed from a plate-shaped transparent resin (a transparent member). Such a transparent member may be various types of materials, such as an acrylic resin, a polycarbonate resin, a methacrylic resin. Further, the gaming board 14 includes, at its front side, a game region 15 which allows launched gaming balls to roll thereon. The game region 15 is a region which is surrounded by a guide rail 30 (more specifically, an outer rail 30a illustrated in FIG. 5, which will be described later) and enables gaming balls to roll thereon. Further, plural nails 13 are driven into the game region 15 of the gaming board 14. On the other hand, the gaming board 14 includes a number-of-rounds display device 51 on its back surface around the center portion thereof.

The liquid crystal display device 32 is placed behind the gaming board 14 (in the side of the back surface thereof) with the spacer 31 interposed therebetween. Namely, the liquid crystal display device 32 is placed behind the transparent member forming the gaming panel 14. The liquid crystal display device 32 has a display region 32a capable of displaying images relating to games. The display region 32a is placed such that the display region 32 is entirely or partially overlapped with the gaming board 14 from the side of the back surface thereof with the spacer 31 sandwiched therebetween. In other words, the display region 32a is placed behind the gaming board 14 such that it is at least entirely or partially overlapped with the game region 15 of the gaming board 14. More specifically, the liquid crystal display device 32 is placed behind the gaming board 14 such that the display region 32a thereof is entirely or partially overlapped with the game region 15 and also is entirely or partially overlapped with the outside region 16 of the game region. Various types of images such as effect images (not shown) and a two-dimensional code 92 are displayed on the display region 32a of the liquid crystal display device 32.

By providing the liquid crystal display device 32 behind the gaming board 14 as in the present embodiment, it is possible to expand the region in which nails can be driven and the region in which gaming members such as combination members, decoration members can be provided and also it is possible to further increase the degree of freedom in layout.

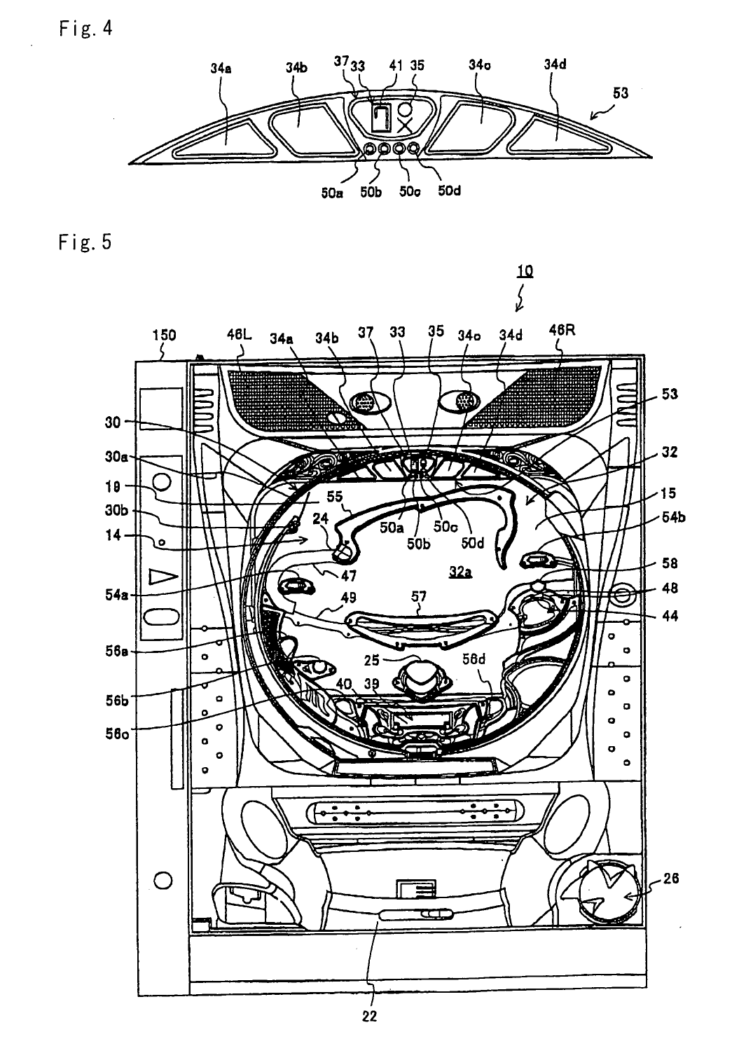

The spacer 31 is placed behind the gaming board 14 (in the side of the back surface thereof) and also is placed at the front of the liquid crystal display device 32 (in the side of the front surface thereof). Namely, the spacer 31 is sandwiched between the gaming board 14 and the liquid crystal display device 32. The spacer 31 is made of a transparent material and is provided with a large through hole 31a at the center thereof. An electric decoration unit 53 is provided within the through hole 31a. The electric decoration unit 53 is constituted by a display device case 37 housing a special symbol display device 33 and a normal symbol display device 35, special symbol hold lamps 34a, 34b, 34c and 34d and normal symbol hold lamps 50a, 50b, 50c and 50d, as illustrated in FIG. 4. The display device case 37 is covered, at its front side, with a transparent lens (not shown), in order to improve the view-ability.

In FIG. 3, for ease of understanding, there are illustrated a first warp path 47 and the number-of-rounds display device 51 provided on the back surface of the gaming board 14. The first warp path 47 is made of a transparent material and is provided for transferring gaming balls which entered a winning opening 24 (see FIG. 5) to a second warp path 49 which will be described later (see FIG. 5).

While, in the present embodiment, the number-of-rounds display device 51 is provided on the back surface of the gaming board 14 around the center thereof, the present invention is not limited thereto and the number-of-rounds display device 51 may be provided, for example, near the upper right end portion of the outer rail 30a on the gaming board 14. Description of the number-of-rounds display device 51 will be provided later.

Next, with reference to FIG. 4, the special symbol display device 33, the normal symbol display device 35, the special symbol hold lamps 34a to 34d and the normal symbol hold lamps 50a to 50d will be described. FIG. 4 is an enlarged view of the electric decoration unit 53.

As illustrated in FIG. 4, the special symbol display device 33 housed in the display device case 37 is constituted by plural 7-segment LEDs 41. The 7-segment LEDs 41 are repeatedly turned on and off, when a predetermined special symbol variable display starting condition is satisfied. When the 7-segment LEDs 41 are turned on and off, ten numerical symbols from “0” to “9” are variably displayed as special symbols (also referred to as identification information). If a specific numerical symbol (for example, a numerical symbol of “3” or “7”) is statically displayed as a special symbol, then the game state is changed from a normal game state to a special game state advantageous to the player. In the event that the game state enters such a big-hit game state, a shutter 40 (see FIG. 5) is controlled to be in a state of open, which enables a special winning opening 39 (see FIG. 5) to receive gaming balls, as will be described later. On the other hand, if a numerical symbol other than the specific numerical symbol (for example, a numerical symbol other than “3” or “7”) is statically displayed as a special symbol, the normal game state is maintained. Games as described above are referred to as “special symbol games”, during which special symbols are variably displayed and then statically displayed and, depending on the result of the static displaying of special symbols, the game state is changed or maintained.

Further, in the pachinko gaming device 10, Effect images are displayed in association with the progress of special symbol games with the liquid crystal display device 32. Effect images displayed with the liquid crystal display device 32 include three effect identification information. These three effect identification information start to be variably displayed in synchronization with the start of variable displaying of special symbols and then are statically displayed in order and, finally, all the effect identification information are statically displayed when a special symbol is statically displayed. If two identical effect identification information are statically displayed, this means the occurrence of a reach state. Further, the effect image displayed at this time notifies the player whether the reach is normal reach or super reach.

The normal symbol display device 35 is provided at the right of the special symbol display device 33. The normal symbol display device 35 is constituted by two display lamps (not shown) and, these display lamps are alternately turned on and off, thereby for example a round mark and a cross mark are variably displayed as normal symbols.

The special symbol hold lamps 34a to 34d are provided at the right and left of the display device case 37. The special symbol hold lamps 34a to 34d indicate the number of times the variable display of special symbols has been held (so-called, “the number of holds”, “the number of holds relating to special symbols”) by turning on or off. For example, when the variable display of special symbols has been held a single time, the special symbol hold lamp 34a is lighted.

The normal symbol hold lamps 50a to 50d are provided under the display device case 37. The normal symbol hold lamps 50a to 50d indicate the number of times the variable display of the normal symbols has been held (so-called, “the number of holds”, “the number of holds relating to the normal symbols”) by turning on and off, as will be described later. Similarly to special symbols, when the variable display of the normal symbols has been held a single time, the normal symbol hold lamp 50a is lighted.

As described above, in the present embodiment, there has been described a case where reach states occur depending on the effect identification information. However, the present invention is not limited to the case and, for example, in cases where plural special symbols are variably displayed, reach states may occur depending on the special symbols.

The description of the external view of the pachinko gaming machine 10 will be continued using FIG. 2 and FIG. 3. A transparent protective plate 19 is placed on the door 11. The transparent protective plate 19 is placed such that it is faced to the front surface of the gaming board 14 in the state where the door 11 is closed.

The launching handle 26 is provided rotatably with respect to the main body frame 12. At the back side of the launching handle 26, there is provided a launching solenoid (not shown) which is a driving device. At the periphery portion of the launching handle 26, there is provided a touch sensor (not shown). When the player touches the touch sensor, it is detected that the player grasps the launching handle 26. When the player grasps the launching handle 26 and rotates it in the clockwise direction, the launching solenoid is fed with electric power depending on the angle of rotation, which causes gaming balls stored on the upper plate 20 to be successively launched to the gaming board 14 for progressing games.

On the display region 32a of the liquid crystal display device 32 placed behind the gaming board 14 (in the side of the back surface thereof), an effect image relating to a special symbol being displayed on the aforementioned special symbol display device 33 is displayed.

Next, with reference to FIG. 5, the general view of the pachinko gaming machine 10 will be described in detail. FIG. 5 is a front view illustrating the general view of the pachinko gaming machine 10 according to the present embodiment. While the general view of the pachinko gaming machine 10 will be described with reference to FIG. 5, the portions of the external view of the pachinko gaming machine 10 which have been previously described with reference to FIG. 2 and FIG. 3 will not be redundantly described. Further, in FIG. 5, illustration of the plural nails 13 driven into the gaming board 14 is omitted.

As illustrated in FIG. 5, there are provided, on the gaming board 14, two guide rails 30 (30a and 30b) and gaming members such as obstruction members 55 and 57, passage gates 54a and 54b, a second warp path 49, an obstruction member 58, a starting opening 25, a starting opening 44 including blade members 48, a shutter 40, a special winning opening 39, regular winning openings 56a, 56b, 56c and 56d. Further, at the upper portion of the gaming board 14, the electric decoration unit 53 including the special symbol display device 33, the normal symbol display device 35 and the like is viewable. The starting openings 25 and 44 correspond to starting regions according to the present invention.

The obstruction member 55 is provided on the gaming board 14 at an upper portion thereof and the obstruction member 57 is provided on the gaming board 14 substantially at the center portion thereof. Further, the obstruction member 58 is provided on the gaming board 14 at the right of the center portion thereof.

The two guide rails 30 provided on the gaming board 14 at the left side thereof are constituted by an outer rail 30a bounding (defining) the game region 15 and an inner rail 30b placed inside the outer rail 30a. Launched gaming balls are guided by the guide rail 30 provided on the gaming board 14, then moved to the upper portion of the gaming board 14, passed over the electric decoration unit 53 and then flowed toward the down side of the gaming board 14 while colliding against the aforementioned plural nails (not shown), the obstruction members 55, 57 and 58 and the like provided on the gaming board 14 to change the direction of movement thereof.

Further, the winning opening 24 is formed at the left end portion of the obstruction member 55. If gaming balls enter the winning opening 24, the gaming balls are passed through the first warp path 47 behind the gaming board 14, then are moved along the rail-shaped second warp path 49 and then are directed to the back side of the obstruction member 57. The gaming balls directed to the back side of the obstruction member 57 are ejected to the front side of the gaming board 14 through the ejecting opening (not shown) surrounded by the obstruction member 57 and then flowed downwardly toward the gaming board 14.

Further, the starting opening 44 is provided at the right of the obstruction member 55. The blade members (so-called normal electric combination members) 48 are provided at the right and left of the starting opening 44.

If a gaming ball enters the aforementioned starting opening 25 or the starting opening 44, the special symbol display device 33 starts to variably display special symbols. Also, if a gaming ball enters the aforementioned starting opening 25 or the starting opening 44 during variable displaying of special symbols, the execution (start) of variable display of special symbols on the basis of the entry of the gaming ball into the starting opening 25 or the starting opening 44 is held until the currently-executed variable display of special symbols ends and a special symbol is statically displayed. Thereafter, when a special symbol which has been variably displayed is statically displayed, the variable display of special symbols which has been held is started.

The passage gates 54a and 54b are provided on the gaming board 14 at the right and left sides thereof substantially at the middle position. In the passage gates 54a and 54b, there are provided passed-ball sensors 114 and 115 (see FIG. 7), which will be described later. The passed-ball sensors 114 or 115 detect gaming balls being passed through the passage gates 54a or 54b. In the event that the passed-ball sensor 114 or 115 detects a gaming ball being passed therethrough, the normal symbol display device 35 starts to variably display the normal symbols and, after the elapse of a predetermined time, the normal symbol display device 35 stops the variable display of the normal symbols. As previously described, the normal symbols are symbols such as a round mark, a cross mark and the like.

If this normal symbol is statically displayed as the predetermined symbol, for example, the round mark, the blade members (so-called normal electric combination members) 48 provided at the right and left of the starting opening 44 are brought into an opened state from the closed state, which causes gaming balls to easily enter the starting opening 44. Further, when a predetermined time has elapsed since the blade members 48 are opened, the blade members 48 are brought into the closed state, which reduces the probability of entry of gaming balls into the starting opening 44. Games as aforementioned are referred to as “normal symbol games”, during which normal symbols are variably displayed and then statically displayed and, depending on the static displaying of normal symbols, the opening/closing state of the blade members 48 is varied.

Similarly to variable display of special symbols, if gaming balls pass through the passage gates 54a and 54b during variable display of normal symbols, the execution (start) of variable displaying of normal symbols on the basis of the passage of the gaming balls through the passage gates 54a and 54b is held until the currently-executed variable display of normal symbols ends and a normal symbol is statically displayed. Thereafter, when a single normal symbol which has been variably displayed is statically displayed, the variable display of normal symbols which has been held is started.

The openable shutter 40 is provided at the front side of the special winning port 39 (at the front thereof). In the event that a specific numerical symbol is statically displayed as a special symbol on the special symbol display device 33 and the game state enters a big-hit game state, the shutter 40 is driven into the opened state where it can easily receive gaming balls. As a result, the special winning port 39 is brought into an opened state (a first state) where it can easily receive gaming balls.

On the other hand, the special winning port 39 provided in the side of the back side of the shutter 40 (behind the shutter 40) has a specific region (not shown) provided with a V-counting sensor 102 (see FIG. 7) and a normal region (not shown) provided with a counting sensor 104 (see FIG. 7) and the shutter 40 is kept driven into the opened state, until a predetermined number (for example, ten) of gaming balls have passed through these regions or until a predetermined time (for example, 30 seconds). has elapsed. If the condition about the entry of the predetermined number of gaming balls into the special winning opening 39 or the condition about the elapse of the predetermined time is satisfied during the opened state, the shutter 40 is driven into the closed state where it can not easily receive gaming balls. As a result, the special winning opening 39 is brought into a closed state (a second state) where it can not easily receive gaming balls. A game which starts at the time the special winning port 39 is brought into the opened state (the first state) where it can easily receive gaming balls and ends at the time the special winning port 39 is brought into the closed state (the second state) where it can not easily receive gaming balls is referred to as a round game. Accordingly, the shutter 40 is kept opened during round games while it is closed at intervals between round games. Further, such round games are counted as the number of rounds such as “1” round, “2” rounds. Further, a first round game is referred to as “a first” round and a second round game is referred to as “a second” round.

Subsequently, the shutter 40 driven into the closed state (the second state) from the opened state is driven into the opened state again, on the condition that a gaming ball enters the special winning opening 39 and passes through the V-counting sensor 102 during the opened state. Namely, on the condition that a gaming ball enters the special winning opening 39 and passes through the V-counting sensor 102 during the opened state of the shutter 40, the game state can continuously proceeds to the next round game. A game which starts with a “first” round game and ends with a (final) round game which can not proceed to the next round game is referred to as a special game.

In the event that a gaming ball enters or passes through the aforementioned starting openings 25 and 44, the regular winning openings 56a to 56d, or the specific region or the normal region of the special winning opening 39, gaming balls are ejected onto the upper plate (see FIG. 2) or the lower plate 22, wherein the number of ejected gaming balls is predetermined on the basis of the types of the respective winning openings.

The number-of-rounds display device 51 provided on the back surface of the gaming board 14 near the center portion thereof displays the number of rounds near the center portion of the game region 15, through the game region 15 of the gaming board 14. The number-of-rounds display device 51 is constituted by plural 7-segment LEDs 52 and is capable of displaying at least one-digit numbers. The number-of-rounds display device 51 may be also constituted by dot LEDs, a liquid crystal display portion or a transparent liquid crystal display portion. Further, the liquid crystal display device 32 is provided behind the number-of-rounds display device 51.

Also, while in the present embodiment the liquid crystal display device 32 constituted by a liquid crystal display panel is employed as a portion for displaying images, the present invention is not limited thereto and may employ other types of displaying portions, such as a Braun tube including a CRT (Cathode Ray Tube), dot LEDs, segment LEDs, ELs (Electronic Luminescents), plasma or the like. Further, while, in the present embodiment, there has been described a case where the liquid crystal display device 32 is provided substantially at the center of the front surface of the gaming board 14 of the pachinko gaming machine 10 as a gaming machine, the liquid crystal display device 32 may be provided at any position which can be viewed from the player. Also, while, in the present embodiment, the special symbol display device 33 and the normal symbol display device 34 are provided in addition to the liquid crystal display device 32, the present invention is not limited thereto and the liquid crystal display device 32 may be configured to variably display special symbols and normal symbols. Further, while the liquid crystal display device 32 is employed as a variable display means, the present invention is not limited thereto and may employ other types of variable display means, such as a drum, a belt, a leaf and the like.

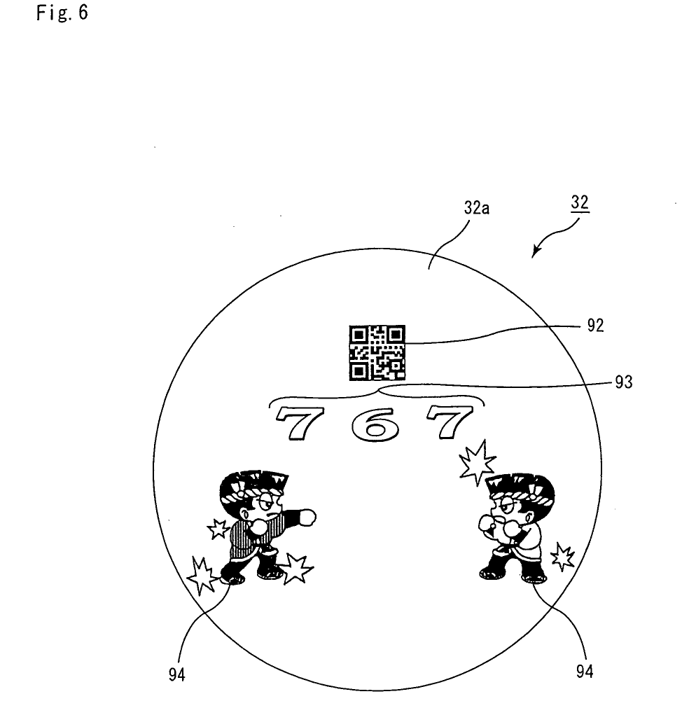

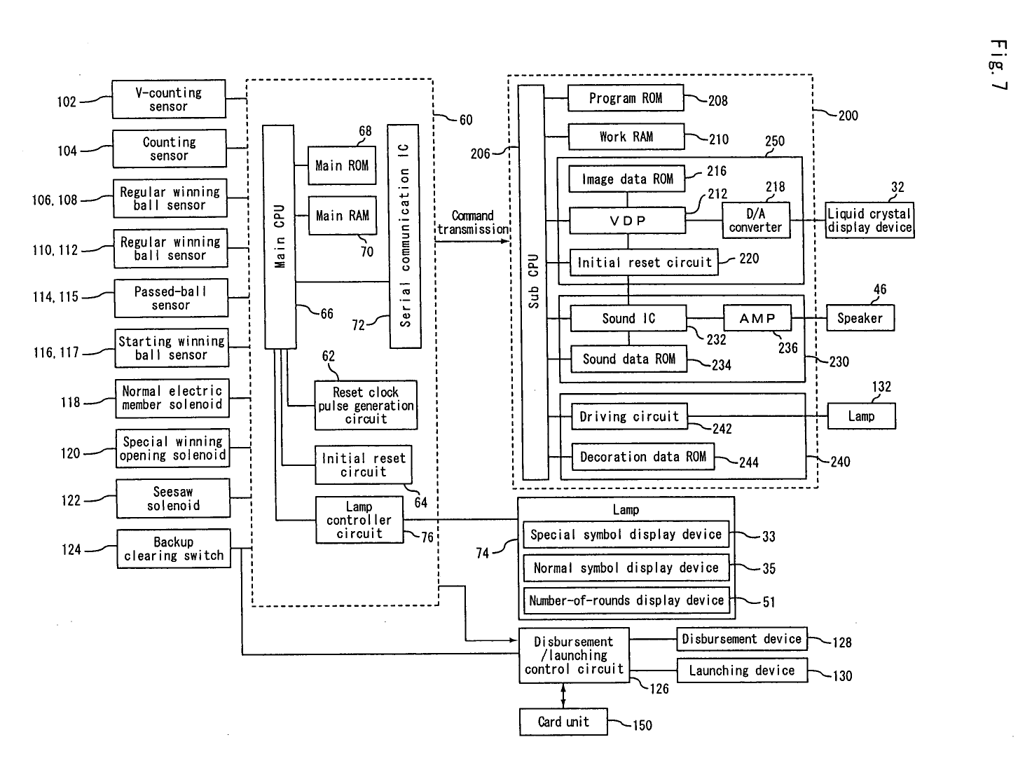

FIG. 6 illustrates an exemplary image being displayed on the liquid crystal display device 32 during super reach. There are displayed three effect identification information 93 which are laterally arranged at the center portion of the liquid crystal display device 32. Among them, the right and left identification information “7” are being statically displayed while the center identification information “6” is being variably displayed. This means the occurrence of reach. Further, on the liquid crystal display device 32, there is displayed an effect image 94 indicating two characters fighting each other, as an effect image indicating that the current reach is super reach. A two-dimensional code 92 is displayed above the effect identification information 93. The player can capture the two-dimensional code 92 displayed on the liquid crystal display device 32 through the transparent protective plate 19 and the gaming board 14 (see FIG. 3), with the CCD camera 408 of the portable telephone 400.

FIG. 7 is a block diagram illustrating a control circuit of the pachinko gaming machine 10 according to the present embodiment. As illustrated in FIG. 7, a main control circuit 60 includes a main CPU 66 as a controlling means, a main ROM (Read Only Memory) 68, and a main RAM (Read Access Memory) 70. The main control circuit 60 controls the progress of games.

The main ROM 68, the main RAM 70 and the like are connected to the main CPU 66 and, the main CPU 66 has the function of performing various types of processes in accordance with programs stored in the main ROM 68. The main ROM 68 stores programs for controlling the operations of the pachinko gaming machine 10 with the main CPU 66 and also stores various types of tables such as a big-hit determination table which is referred to in performing big-hit determination through random number lottery.

The main RAM 70 has the function of storing various flags and variable values, as a temporal storage region of the main CPU 66. As specific examples of data stored in the main RAM 70, there is data as follows. In the main RAM 70, there are positioned a control state flag, a specific region passage flag, a big-hit determination random number counter, a big-hit symbol determination random number counter, a failure symbol determination random number counter, an effect condition selection random number counter, a

number-of-special-winning-opening-opens counter, a special winning opening entry counter, a number-of-rounds display counter, a waiting time timer, a special winning opening open time timer, data indicative of the number of holds relating to special symbols, data indicative of the number of holds relating to normal symbols, data for transmitting commands to a sub control circuit 20 which will be described later, variables and the like.

The control state flag indicates the control state for special symbols. The specific region passage flag is used for determining whether or not gaming balls have passed through the specific region.

The big-hit determination random number counter is used for determining whether or not a special symbol big hit should be occurred. The big-hit symbol determination random number counter is used for determining a special symbol to be statically displayed, if it is determined that a special symbol big hit should be occurred. The failure symbol determination random number counter is used for determining a special symbol to be statically displayed, if it is not determined that a special symbol big hit should be occurred. The effect condition selection random number counter is for determining an effect variation pattern. These counters are updated by the main CPU 66 such that their stored values are incremented one by one, and random numbers are sampled from the respective counters at predetermined timings to execute various functions of the main CPU 66. While, in the present embodiment, these random counters are provided and the main CPU 66 is configured to update these random counters such that their stored values are incremented one by one, in accordance with programs, the present invention is not limited thereto and there may be provided a separate random number generation circuit.

The waiting time timer is provided for synchronization between processes conducted by the main control circuit 60 and the sub control circuit 200. Further, the special winning opening open time timer is for measuring the time during which the shutter 40 is driven to keep the special winning opening 39 opened. Further, while in the present embodiment the timers are updated at predetermined intervals, in the main RAM 70, such that their count values are subtracted by the predetermined interval, the present invention is not limited thereto and the CPU and the like may include timers.

The number-of-special-winning-opening-opens counter indicates the number of times the special winning opening has been opened during a big-hit game state (so-called, the number of rounds). Further, the special winning opening entry counter indicates the number of gaming balls which have entered the special winning opening and passed through the V-counting sensor 102 or the counting sensor 104 during a single round. The data indicative of the number of holds relating to special symbols indicates the number of times a special symbol game has been held, since even if a gaming ball enters the starting opening 25 or 44, the start of a special symbol game is held when variable displaying of special symbols can not be executed. Further, the data indicative of the number of holds relating to normal symbols indicates the number of times a normal symbol game has been held, since even if a gaming ball passes through the passage gate 54a or 54b, the start of a normal symbol game is held when variable displaying of normal symbols can not be executed. The number-of-rounds display counter indicates the number of rounds to be displayed on the number-of-rounds display device 51.

Further, the main control circuit 60 includes a reset clock pulse generation circuit 62 for generating clock pulses with a predetermined frequency, an initial reset circuit 64 for generating a reset signal at power-up, and a serial communication IC 72 for transmitting commands to the sub control circuit 200 which will be described later. The reset clock pulse generation circuit 62, the initial reset circuit 64 and the serial communication IC 72 are connected to the main CPU 66. Further, the reset clock pulse generation circuit 62 generates clock pulses at predetermined intervals (for example, at 2-miliseconds intervals), in order to conduct a system timer interruption process which will be described later.

Further, to the main control circuit 60, there are connected various types of devices such as the V-counting sensor 102, the counting sensor 104, regular winning ball sensors 106, 108, 110 and 112, passed-ball sensors 114 and 115, starting winning ball sensors 116 and 117, a normal electric combination member solenoid 118, a special winning opening solenoid 120, a seesaw solenoid 122, a backup clearing switch 124, as illustrated in FIG. 7.

The V-counting sensor 102 is provided in the specific region of the special winning opening 39. In the event that a gaming ball passes through the specific region of the special winning opening 39, the V-counting sensor 102 transmits a predetermined detection signal to the main control circuit 60. The counting sensor 104 is provided in the normal region of the special winning opening 39 which is different from the specific region. In the event that a gaming ball passes through the normal region of the special winning opening 39, the counting sensor 104 transmits a predetermined detection signal to the main control circuit 60. The regular winning ball sensors 106, 108, 110 and 112 are provided in the regular winning openings 56a to 56d, respectively. In the event that a gaming gall passes through the normal winning openings 56a to 56d, the regular winning ball sensors 106, 108, 110 and 112 transmit a predetermined detection signal to the main control circuit 60.

The passed-ball sensors 114 and 115 are provided in the passage gates 54a and 54b, respectively. In the event that a gaming ball passes through the passage gate 54a or 54b, the passed-ball sensor 114 or 115 transmits a predetermined detection signal to the main control circuit 60. The starting winning ball sensors 116 and 117 are provided in the starting openings 25 and 44, respectively. In the event that a gaming ball enters the starting opening 25 or 44, the starting winning ball sensor 116 or 117 transmits a predetermined detection signal to the main control circuit 60. The normal electric combination member solenoid 118 is connected to the blade members 48 through a link member (not shown) and brings the blade members 48 into the opened state or the closed state, in response to driving signals transmitted from the main CPU 66.

The special winning opening solenoid 120 is connected to the shutter 40 illustrated in FIG. 5 and drives the shutter 40 to open or close the special winning opening, in response to driving signals transmitted from the main CPU 66. The seesaw solenoid 122 is connected to a plate-shaped seesaw (not shown) provided inside the shutter 40 and moves the seesaw to change the inclination of the seesaw, in response to driving signals transmitted from the main CPU 66. By inclining the seesaw, the seesaw is switched between a state which allows gaming balls to easily pass through the specific region and a state which allows gaming balls to easily pass through the normal region. The backup clearing switch 124 is incorporated in the pachinko gaming machine 10 and has the function of clearing data which was backed up at power-off and the like, in accordance with operations of an administrator of the game arcade.

The disbursement/launching control circuit 126 is connected to the main control circuit 60. A disbursement device 128 for disbursing gaming balls, a launching device 130 used for launching gaming balls and a card unit 150 are connected to the disbursement/launching control circuit 126.

The disbursement/launching control circuit 126 receives ball winning control commands transmitted from the main control circuit 60 and ball rental control signals transmitted from the cart unit 150 and transmits predetermined signals to the disbursement device 128 to cause the disbursement device 128 to disburse gaming balls. Further, the disbursement/launching control circuit 126 transmits launching signals to the launching device 130 for controlling it to launch gaming balls. While, in the present embodiment, there will be described a case where the disbursement/launching control circuit 126 is connected to the main control circuit 60 and is controlled by the main CPU 66, the present invention is not limited thereto and, for example, the disbursement/launching control circuit 126 may be connected to the sub control circuit 200 and may be controlled by a sub CPU 206.

The launching device 130 includes devices for launching gaming balls, such as the aforementioned launching solenoid, the touch sensor and the like. When the player grasps the launching handle 26 and rotates it in the clockwise direction, the launching solenoid is fed with electric power according to the angle of rotation to successively launch gaming balls stored on the upper plate 20 towards the gaming board 14.

A lamp controller circuit 76 for controlling lamps 74 is connected to the main control circuit 60, and the lamps 74 are connected to the lamp controller circuit 76. The lamp controller circuit 76 transmits lamp (LED) controlling signals to the lamps 74. The lamps 74 include incandescent lamps, LEDs and the like and more specifically include the special symbol hold lamps 34a to 34d, the normal symbol hold lamps 50a to 50d, the special symbol display device 33 (7-segment LEDs 41), the normal symbol display device 35 (displaying lamps), the number-of-rounds display device 51 (7-segment LEDs 52) and the like.

On the other hand, the sub control circuit 200 is connected to the serial communication IC 72. The sub control circuit 200 controls the display on the liquid crystal display device 32, sound to be generated from a speaker 46, lamps 132, in response to various commands transmitted from the main control circuit 60. The lamps 132 include incandescent lamps, LEDs and the like and, more specifically, include decoration lamps (not shown) for displaying the gaming board 14 in a dark and bright manner.

While, in the present embodiment, the main control circuit 60 transmits commands to the sub control circuit 200 while the sub control circuit 200 is not capable of transmitting signals to the main control circuit 60, the present invention is not limited thereto and the sub control circuit 200 may be configured to be capable of transmitting signals to the main control circuit 60.

The sub control circuit 200 is constituted by the sub CPU 206, a program ROM 208, a work RAM 210, a display control circuit 250 for controlling the display on the liquid crystal display device 32, a sound control circuit 230 for controlling sound to be generated from the speaker 46 and a lamp control circuit 240 for controlling the lamps 132. The sub control circuit 200 executes effects in accordance with the progress of games, in response to commands from the main control circuit 60.

The program ROM 208, the work RAM 210 and the like are connected to the sub CPU 206. The sub CPU 206 has the function of executing various types of processes, in accordance with programs stored in the program ROM 208. Particularly, the sub CPU 206 controls the sub control circuit 200, in accordance with various commands transmitted from the main control circuit 60. Particularly, the sub CPU 206 controls the display on the liquid crystal display device 32.

Further, when the sub CPU 206 selects an effect pattern for displaying a specific reach image on the liquid crystal display device 32 on the basis of a variation pattern designation command, it reads output information associated with the reach image from the program ROM 208, encodes the output information to generate a two-dimensional code and stores it in the work RAM 210. Further, the sub CPU 206 extracts a two-dimensional code display pattern from the program ROM 208 and transmits it to a VDP 212. The two-dimensional code display pattern includes various types of data for displaying the two-dimensional code, such as the position and the time period at and during which the two-dimensional code is to be displayed. As will be described later, on receiving the two-dimensional code display pattern, the VDP 212 conducts a process for reading the two-dimensional code from the work RAM 210 and displaying it on the liquid crystal display device 32, on the basis of the two-dimensional code display pattern. While, in the present embodiment, there will be described a case where output information is encoded to generate a two-dimensional code, the two-dimensional code may be pre-stored in an image data ROM 216 or the like, in the present invention.

The program ROM 208 stores programs for controlling game effects in the pachinko gaming machine 10 through the sub CPU 206 and also stores various types of tables such as tables for making determinations relating to effects, a table associating set values with output information (hereinafter, also referred to as an “output information table”). Further, in the present embodiment, the output information is an URL indicative of a predetermined address (the address of a web site of the gaming machine maker) in the server 600 in the Internet.

Further, the program ROM 208 stores plural types of effect patterns. The effect patterns relate to the progress of effect displaying which is executed in association with variable displaying of special symbols. In addition, the program ROM 208 stores plural types of effect patterns used during playing of special games. The effect patterns used during playing of special games relate to the progress of effect displaying which is executed in association with round games during special games.

While, in the present embodiment, the main control circuit 60 is configured to utilize the main ROM 68 and the sub control circuit 200 is configured to utilize the program ROM 208 as storage means for storing programs, tables and the like, the present invention is not limited thereto and may employ any other types of storage media which are readable by computers including control means and, for example, such programs, tables and the like may be stored in a storage medium such as a hard disk device, a CD-ROM, a DVD-ROM, a ROM cartridge and the like. As a matter of cause, the main ROM 68 may be utilized instead of the program ROM 208. Also, these programs may be downloaded after power-up and then recorded in the main RAM 70 in the main control circuit 60 and in the work RAM 210 or the like in the sub control circuit 200, rather than be pre-recorded. Also, the respective programs may be recorded in different recording media.

The work RAM 210 has the function of storing various flags and variable values, as a temporal storage region of the sub CPU 206. For example, there are positioned, therein, an effect display selection random number counter used for selecting effect patterns, various types of variable values and the like. Further, the work RAM 210 stores two-dimensional code generated by encoding output information.

Further, while, in the present embodiment, the main RAM 70 is utilized as a temporal storage region of the main CPU 66 and the work RAM 210 is utilized as a temporal storage region of the sub CPU 206, the present invention is not limited thereto and may employ any read-and-write storage media.

The display control circuit 250 functions as a display control means and is constituted by an image data processor (hereinafter, referred to as a VDP) 212, an image data ROM 216 for storing various types of image data, a D/A converter 218 for converting image data into image signals, and an initial reset circuit 220 for generating a reset signal at power-up. The aforementioned VDP 212 is connected to the sub CPU 206, the image data ROM 216, the D/A converter 218, and the initial reset circuit 220.

The VDP 212 is a device including circuits such as a so-called sprite circuit, a screen circuit, a palette circuit and capable of performing various processes for displaying images on the liquid crystal display device 32. Namely, the VDP 212 controls the display on the liquid crystal display device 32. Further, the VDP 212 includes a storage medium (for example, a video RAM) as a buffer used for displaying images on the display region 32a of the liquid crystal display device 32. By storing image data in a predetermined storage region of the storage medium, an image is displayed on the display region 32a of the liquid crystal display device 32 at predetermined timing.

The image data ROM 216 separately stores various types of image data, such as effect identification information image data indicative of effect identification information, background image data, effect image data and the like. As a matter of cause, it further stores related-image data indicative of related images.

The VDP 212 extracts various types of image data, such as effect identification information image data, background image data, effect image data and the like, from the image data ROM 216, in response to image display commands (commands) transmitted from the sub CPU 206. Further, on receiving a two-dimensional code display pattern from the sub CPU 206, the VDP 212 extracts a two-dimensional code from the work RAM 210 on the basis of the two-dimensional code display pattern.

The VDP 212 superimposes the various types of images extracted from the image data ROM 216 or the work RAM 210 on one another in the order in which they are to be placed from a rearmost position, for example, in the order of the background image, the effect image and the two-dimensional code, and stores them in the buffer (for example, a video RAM) to synthesize a screen image and then outputs it to the D/A converter 218 at predetermined timing. The D/A converter 218 converts the screen image into image signals and outputs the image signals to the liquid crystal display device 32. As a result, a two-dimensional code 92 is displayed in the display region 32a of the liquid crystal display device 32 (see FIG. 6). The player can capture the two-dimensional code 92 displayed on the liquid crystal display device 32 with the CCD camera 408 included in the portable telephone 400.

While, in the present embodiment, there has been described a case where the sub CPU 206 encodes output information to generate a two-dimensional code, the two-dimensional code may be stored in a storage means included in the gaming machine in the present invention.

Further, the sound control circuit 230 is constituted by a sound source IC 232 for performing control relating to sound, an audio data ROM 234 for storing various types of sound data, and an amplifier 236 for amplifying sound signals (hereinafter, referred to as an AMP).

The sound source IC 232 is connected to the sub CPU 206, the initial reset circuit 220, the audio data ROM 234 and the AMP 236. The sound source IC 232 controls sound to be generated from the speaker 46.

The lamp control circuit 240 is constituted by a driving circuit 242 for generating lamp (LED) controlling signals and a decoration data ROM 244 storing plural types of lamp decoration patterns (LED lighting patterns) and the like.

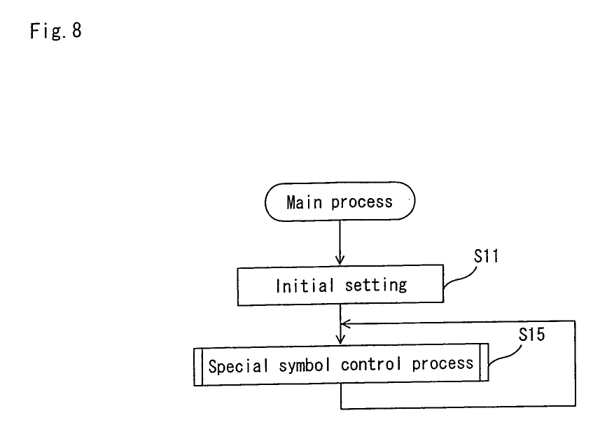

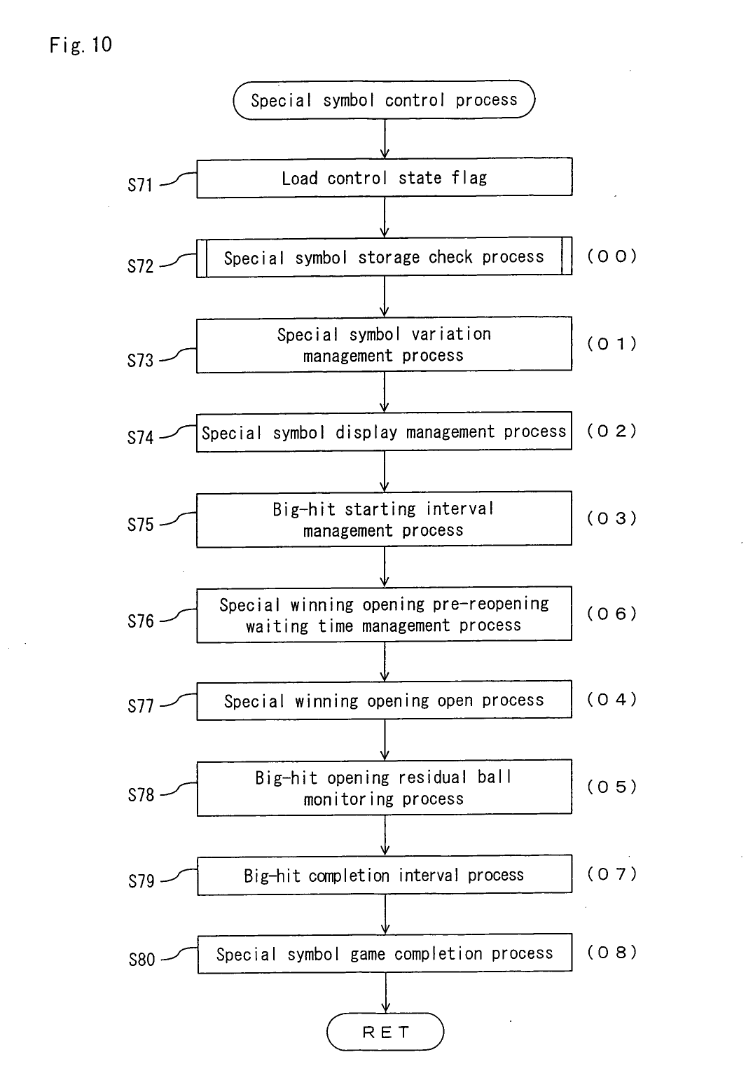

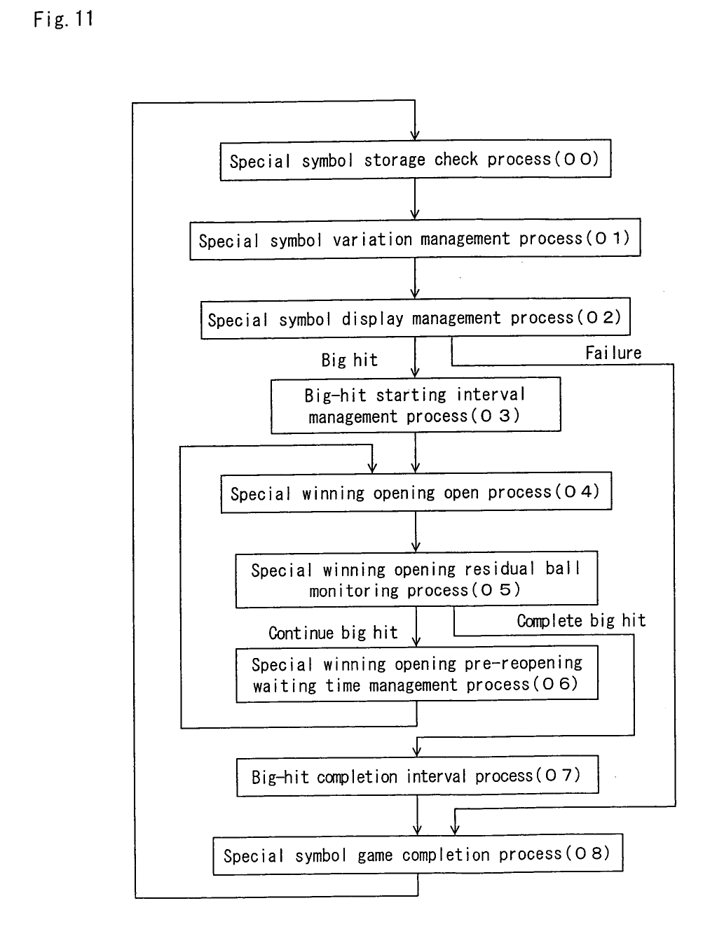

Hereinafter, FIGS. 8 to 10 and FIGS. 12 to 20 illustrate a process which is conducted in the pachinko gaming machine 10. Further, with reference to FIG. 11, there will be described state transitions during special symbol control process (FIG. 10) conducted in the gaming machine 10.

FIG. 8 illustrates a main process conducted in the main control circuit 60.

First, as illustrated in FIG. 8, an initial setting process is conducted, wherein the initial setting process includes RAM access permission, backup restoration, initialization of work areas (step S11). Then, special symbol control process is conducted, wherein the special symbol control process relates to the progress of special symbol games and special symbols on the special symbol display device 33 (step S15), as will be described in detail with reference to FIG. 10. As described above, in the main process, after the completion of the initial setting processes in step S11, the process in step S15 is repeatedly conducted.

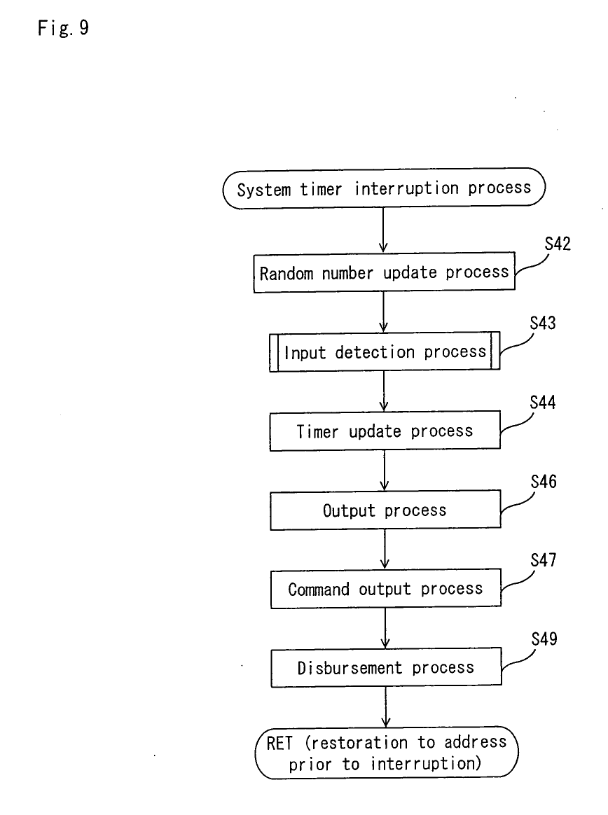

Further, even when the main CPU 66 is executing the main process, the main CPU 66 may interrupt the main process and conduct a system timer interruption process. In response to clock pulses which are generated from the reset clock pulse generation circuit 62 at predetermined intervals (for example, at 2-milisecond intervals), the main CPU 66 conducts the following system timer interruption process. The system timer interruption process will be described with reference to FIG. 9.

First, as illustrated in FIG. 9, the main CPU 66 conducts a random number update process for incrementing, by “1”, the respective counter values of the big-hit determination random number counter, the big-hit symbol determination random number counter and the like (step S42). Then, the main CPU 66 conducts an input detection process for detecting gaming balls entering or passing through the starting openings 25 or 44 or the like (step S43). Then, the main CPU 66 conducts a process for updating various types of timers, such as the waiting time timer used for synchronization between the main control circuit 60 and the sub control circuit 200, the special winning opening open time timer for measuring the time during which the special winning opening 39 has been opened, wherein the special winning opening 39 is opened in the event of the occurrence of a big hit (step S44). Then, the main CPU 66 conducts an output process, in order to transmit, to solenoids, a motor and the like, signals for driving and controlling them on the basis of various types of variable values (step S46). After the completion of this process, the process proceeds to step S47.

In step S47, command output process is conducted. In this process, the main CPU 66 transmits various types of commands to the sub control circuit 200. Specifically, these various types of commands include a variation pattern designation command indicative of the pattern of variable display of special symbols and the like. After the completion of the process, the process proceeds to step S49.

Then, in step S49, the main CPU 66 conducts a disbursement process for transmitting ball winning control commands for causing the disbursement device 128 to disburse balls, to the disbursement/launching control circuit 126. Further, the main CPU 66 transmits, to the disbursement/launching control circuit 126, ball winning control commands for causing it to disburse a predetermined number of balls, in the event of entry of a gaming ball into the various types of winning openings. After the completion of the process, this subroutine ends and main CPU 66 is restored to an address at which it existed prior to the occurrence of the interruption and conducts the main process.

With reference to FIG. 10, the subroutine conducted in step S15 of FIG. 8 will be described. In FIG. 10, the numerical values represented at the sides of steps S72 to S81 indicate the numerical values of the control state flag corresponding to the respective steps and, on the basis of the current numerical value of the control state flag, a single step corresponding to the numerical value is conducted to progress special symbol games.

First, as illustrated in FIG. 10, a process for loading the control state flag is conducted (step S71). In this process, the main CPU 66 reads the control state flag. After the completion of this process, the process proceeds to step S72.

Further, in steps S72 to S81 which will be described later, on the basis of the value of the control state flag, the main CPU 66 determines whether or not various types of processes at the respective steps should be conducted. The control state flag indicates the game state of special symbol games and allows one of the processes in steps S72 to S81 to be conducted. In addition thereto, the main CPU 66 conducts the process at the respective steps at predetermined timing based on the waiting time timer, wherein the predetermined timing is set for the respective steps. Further, prior to the predetermined timing, the subroutine ends without conducting the process at the respective steps and another subroutine is conducted. As a matter of cause, the system timer interruption process is conducted at predetermined intervals.

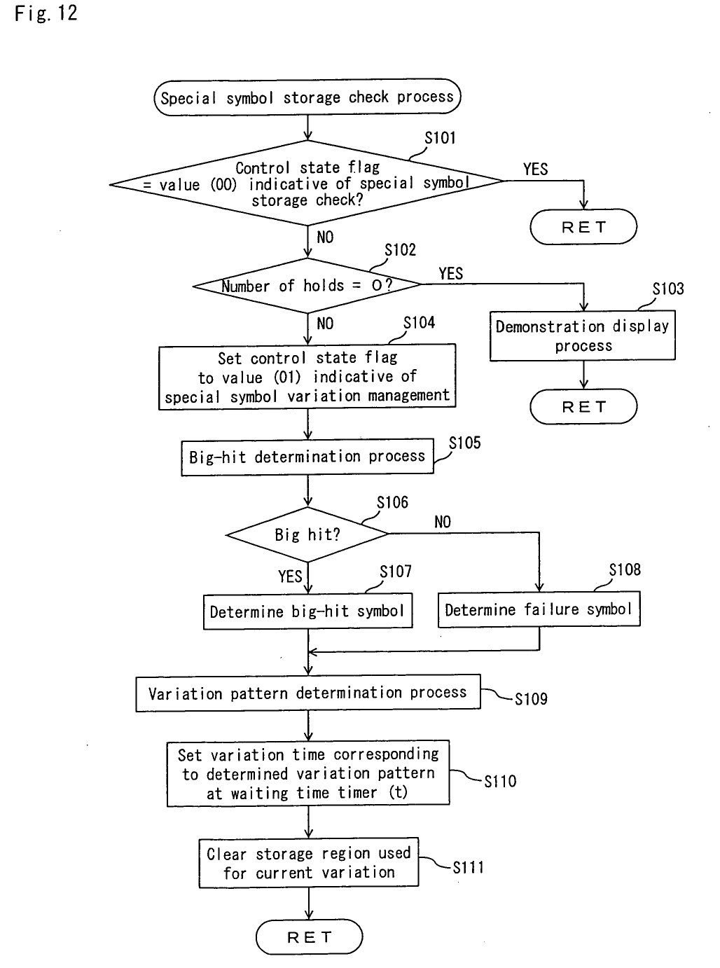

In step S72, special symbol storage check process is conducted. The detail thereof will be described later with reference to FIG. 12. After the completion of this process, the subroutine proceeds to the process in step S73.

In step S73, a special symbol variation management process is conducted. In the process, the control state flag has a value (01) indicative of special symbol variation management and, after the elapse of a variation time, the main CPU 66 sets the control state flag to a value (02) indicative of special symbol display management and also sets the waiting time timer to a post-determination waiting time (for example, one second). Namely, the process in step S74 is set to be conducted after the elapse of the post-determination waiting time. At the completion of this process, the subroutine proceeds to the process in step S74.

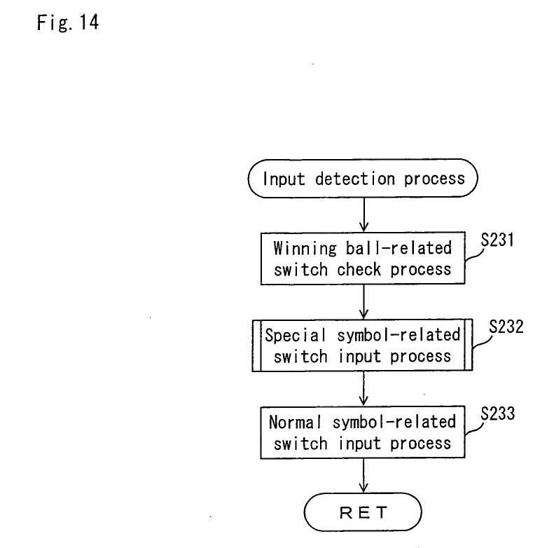

In step S74, a special symbol display management process is conducted. The detail thereof will be described later with reference to FIG. 14. After the completion of this process, the subroutine proceeds to the process in step S75.

In step S75, a big-hit starting interval management process is conducted. In this process, the control state flag has a value (03) indicative of big-hit starting interval management and, after the elapse of a time corresponding to the big-hit starting interval, the main CPU 66 stores, in the main RAM 70, data for opening the special winning opening 39, which has been read from the main ROM 68. Then, the main CPU 66 reads data for opening the special winning opening 39, which has been stored in the main RAM 70 in step S46 in FIG. 9, and transmits a signal commanding for opening the special winning opening 39 to the special winning opening solenoid 120. As described above, the main CPU 66 controls the opening/closing of the special winning opening 39. Namely, a special game in which a round game can be repeatedly executed in plural times is executed, wherein a predetermined advantageous game state (a game state which starts with an opened state where gaming balls can easily enter the special winning opening 39 and ends with a closed state where gaming balls can not easily enter the special winning opening 39) is offered in the round game.

Further, the main CPU 66 sets the control state flag to a value (04) indicating that the special winning opening is being opened and also sets the special winning opening open time timer to an opening upper limit time (for example, 30 seconds) Namely, the main CPU 66 sets the configuration such that the process in step S78 is conducted. Further, the main CPU 66 substitutes a predetermined number (for example, “15”) into the number-of-rounds display counter in the main RAM 70. After the completion of this process, the subroutine proceeds to the process in step S76.

In step S76, a number-of-rounds display process is conducted. In this process, the main CPU 66 selects a single number-of-rounds displaying pattern from plural number-of-rounds displaying patterns stored in the main ROM 68, on the basis of the number substituted in the number-of-rounds display counter stored in a predetermined region of the main RAM 70, and stores the selected number-of-rounds displaying pattern in a predetermined region of the main RAM 70.

Further, the data indicative of the number-of-rounds displaying pattern stored in the predetermined region of the main RAM 70 is transmitted to the lamp controller circuit 76, as a signal for controlling the display on the number-of-rounds display device 51 (a number-of-rounds display controlling signal), through the process in step S46. On receiving the number-of-rounds display controlling signal, the lamp controller circuit 76 controls variable display and static display on the number-of-rounds display device 51, on the basis of the number-of-rounds display controlling signal. After the completion of this process, the subroutine proceeds to the process in step S77.

In step S77, a special winning opening pre-reopening waiting time management process is conducted. In this process, the control state flag has a value (06) indicative of special winning opening pre-reopening waiting time management and, after the elapse of a time corresponding to the inter-round interval, the main CPU 66 updates the

number-of-special-winning-opening-opens counter such that the stored value is incremented by “1”. The main CPU 66 sets the control state flag to a value (04) indicating that the special winning opening is being opened. The main CPU 66 sets the special winning opening open time timer to an opening upper limit time (for example, 30 seconds). Namely, the main CPU 66 sets the configuration such that the process in step S78 is conducted. After the completion of this process, the subroutine proceeds to the process in step S78.

In step S78, a special winning opening open process is conducted. In this process, in the case where the control state flag has the value (04) indicating that the special winning opening is being opened, the main CPU 66 determines whether or not either the condition that the special winning opening entry counter is equal to or greater than “10” or the condition that the opening upper limit time has elapsed (the special winning opening open time timer is “0”) is satisfied. If any of the conditions is satisfied, the main CPU 66 updates the variable values positioned in the main RAM 70, in order to close the special winning opening 39. The main CPU 66 sets the control state flag to a value (05) indicative of monitoring of residual balls within the special winning opening. The main CPU 66 sets the waiting time timer to a special winning opening residual ball monitoring time (for example, 1 second). Namely, the main CPU 66 sets the configuration such that the process in step S79 is conducted after the elapse of the special winning opening residual ball monitoring time. Further, if either condition is not satisfied, the main CPU 66 does not conduct the aforementioned process. After the completion of this process, the subroutine proceeds to the process in step S79.

In step S79, a special winning opening residual ball monitoring process is conducted. In this process, the control state flag has the value (05) indicative of monitoring of residual balls within the special winning opening and, after the elapse of the special winning opening residual ball monitoring time, the main CPU 66 determines whether or not the condition that no gaming ball has passed through the specific region of the special winning opening 39 or the condition that the number-of-special-winning-opening-opens counter is equal to or greater than a maximum number of continuous rounds (indicative of a final round) is satisfied. If any of the conditions is satisfied, the main CPU 66 sets the control state flag to a value (07) indicative of a big-hit completion interval and also sets the waiting time timer to a time corresponding to the big-hit completion interval. Namely, the main CPU 66 sets the configuration such that the process in step S80 is conducted after the elapse of a time corresponding to the big-hit completion interval. On the other hand, if both the conditions are not satisfied, the main CPU 66 sets the control stage flag to a value (06) indicative of special winning opening re-opening waiting time management. Further, the main CPU 66 updates the number-of-rounds display counter stored in the main RAM 70 such that the stored value is subtracted by “1”. Further, the main CPU 66 sets the waiting time timer to a time corresponding to the inter-round interval. Namely, the main CPU 66 sets the configuration such that the process in step S76 is conducted after the elapse of the time corresponding to the inter-round interval. After the completion of this process, the subroutine proceeds to the proceeds in step S80.

In step S80, big-hit completion interval process is conducted. In this process, the control state flag has the value (07) indicative of the big-hit completion interval and, after the elapse of the time corresponding to the big-hit completion interval, the main CPU 66 sets the control state flag to a value (08) indicative of the completion of special symbol games. Namely, the main CPU 66 sets the configuration such that the process in step S81 is conducted. After the completion of this process, the subroutine proceeds to the process in step S81.

In step S81, a special symbol game completion process is conducted. In this process, when the control state flag has a value (08) indicative of the completion of special symbol games, the main CPU 66 updates the data indicative of the number of holds relating to special symbols (starting storage information) such that it is subtracted by “1”. Further, the main CPU 66 sets data indicative of a number-of-starting-storage designation command for subtracting the starting storage information by “1” in a predetermined storage region of the main RAM 70. Further, the main CPU 66 updates the special symbol storage region, in order to perform the next variable display. The main CPU 66 sets the control state flag to a value (00) indicative of special symbol storage checking. Namely, the main CPU 66 sets the configuration such that the process in step S72 is conducted. After the completion of this process, this subroutine ends.

As previously described, by setting the control state flag, special symbol games are executed. Specifically, as illustrated in FIG. 11, when the game state is not a big-hit game state, if “failure” is resulted from a big-hit determination, the main CPU 66 sets the control flag state to “00”, “01”, “02” and “08” in the mentioned order to conduct the process in steps S72, S73, S74 and S81 illustrated in FIG. 10 at predetermined timing. Also, when the game state is not a big-hit game state, if a big hit is resulted from a big-hit determination, the main CPU 66 sets the control flag state to “00”, “01”, “02” and “03” in the mentioned order to conduct the process in steps S72, S73, S74 and S75 illustrated in FIG. 10 at predetermined timing to perform the control of a big-hit game state. Also, when the control of the big-hit game state is performed, the main CPU 66 sets the control flag state to “04”, “05” and “06” in the mentioned order to conduct the process in steps S78, S79 and S77 illustrated in FIG. 10 at predetermined timing to perform special games. Further, if the condition for completing special games (a big-hit game state) (the condition for completing special games, the condition for completing big-hit games) is satisfied, the main CPU 66 sets the control state flag to “04”, “05”, “07” and “08” in the mentioned order to conduct the process in steps S78 to 81 illustrated in FIG. 10 at predetermined timing to complete special games. Further, in the present embodiment, the condition for completing special games includes the condition that no gaming ball has passed through the specific region until a predetermined time has elapsed (“blown out state”) and the condition that the maximum number of continuous rounds has been completed.

FIG. 12 is a flowchart illustrating the subroutine of the special symbol storage check process which is called up and conducted in step S72 in the subroutine illustrated in FIG. 10.

First, as illustrated in FIG. 12, the main CPU 66 determines whether or not the control state flag has the value (00) indicative of special symbol storage check (step S101). If it is determined that the control state flag has the value indicative of special symbol storage check, the subroutine proceeds to the process in step S102 and, if it is not determined that the control state flag has the value indicative of special symbol storage check, this subroutine ends.

In step S102, the main CPU 66 determines whether or not the number of holds relating to special symbols is “0”. If it is determined that the data indicative of the number of holds relating to special symbols is “0”, then the subroutine proceeds to the process in step S103 and, if it is not determined that the data indicative of the number of holds is “0”, then the subroutine proceeds to the process in step S104.

In step S103, a demonstration display process is conducted. In this process, the main CPU 66 stores, in the main RAM 70, a variable value used for transmitting a demonstration display command to the sub control circuit 200 for causing it to perform demonstration displaying. This causes the sub control circuit 200 to display a demonstration screen. After the completion of this process, this subroutine ends.

In step S104, a process for setting the control state flag to the value (01) indicative of special symbol variation management is conducted. In this process, the main CPU 66 stores the value indicative of special symbol variation management in the control state flag. After the completion of this process, the subroutine proceeds to the process in step S105.

In step S105, a big-hit determination process is conducted. In this process, the main CPU 66 selects a big-hit determination value stored in the big-hit determination table. Further, the main CPU 66 refers to the big-hit determination random number extracted at starting winning and the big-hit determination value. Namely, the main CPU 66 determines whether or not a big-hit game state advantageous to the player should be occurred. After the completion of this process, the subroutine proceeds to the process in step S106.

In step S106, it is determined whether or not a big hit has occurred. In this process, the main CPU 66 determines whether or not a big hit has occurred, on the basis of the result of the reference in step S105. If the main CPU 66 determines that a big hit has occurred, the subroutine proceeds to the process in step S107 and, if it does not determine that a big hit has occurred, the subroutine proceeds to the process in step S108.

In step S107, a big-hit symbol determination process is conducted.

In this process, the main CPU 66 extracts a big-hit symbol random number extracted at starting winning, then determines a special symbol to be statically displayed on the special symbol display device 33 on the basis of the big-hit symbol determination random number and stores data indicative of the special symbol in a predetermined region of the main RAM 70. After the completion of this process, the subroutine proceeds to the process in step S109.

In step S108, a failure symbol determination process is conducted.

In this process, the main CPU 66 extracts a failure symbol determination random number from a failure symbol determination random number counter, then determines a special symbol to be statically displayed on the special symbol display device 33 as a failure symbol and stores data indicative of the special symbol in a predetermined region of the main RAM 70. After the completion of this process, the subroutine proceeds to the process in step S109.

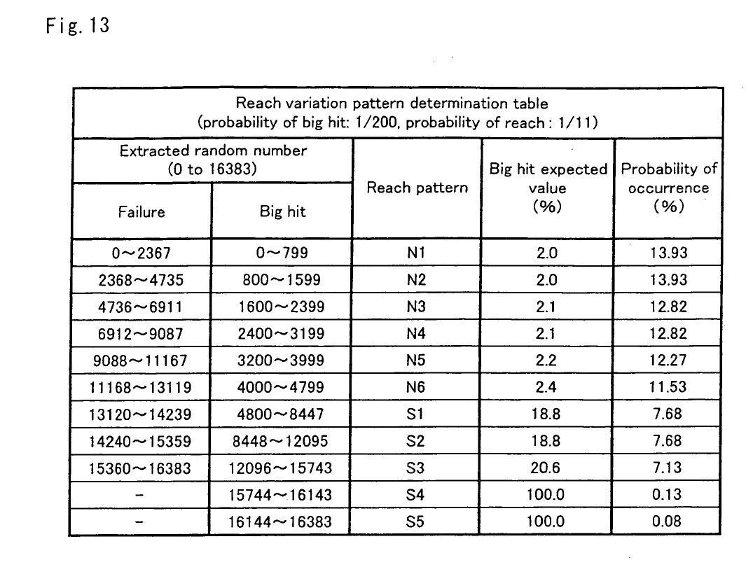

In step S109, a process for determining a special symbol variation pattern is conducted. In this process, the main CPU 66 determines a variation pattern and stores it in a predetermined region of the main RAM 70. Specifically, in the case where a big-hit symbol has been determined in step S107, the main CPU 66 performs random number sampling and refers to a reach variation pattern determination table (see FIG. 13) stored in the program ROM 208 to determine the variation pattern. On the other hand, in the case where a failure symbol has been determined in step S109, the main CPU 66 performs random number sampling to determine whether or not a reach state should be occurred. If the main CPU 66 determines that a reach state should be occurred, it further performs random number sampling and refers to the reach variation pattern determination pattern (see FIG. 13) stored in the program ROM 208 to determine a variation pattern.

FIG. 13 is an exemplary reach variation pattern determination table.

In this figure, N1 to N6 indicate normal reaches and S1 to S5 indicate super reaches. Further, S4 and S5 indicate super reaches having a big-hit expected value of 100% (so-called premium reaches).

In the pachinko gaming machine 10, different reach images are set for the respective reaches. The reach images displayed during the super reaches correspond to specific reach images in the present invention. As illustrated in FIG. 13, the probabilities of occurrence of the supper reaches are lower than the probabilities of occurrence of the normal reaches and, namely, the specific reach images used during super reaches are image data which is less likely to be selected out of the plural types of reach images.

Further, in the case where the main CPU 66 has determined a failure symbol in step S109 and further has determined that a reach state is not to be occurred, it performs random number sampling and refers to a normal variation pattern determination table (not shown) to determine a variation pattern.

Further, the main CPU 66 stores data indicative of the determined variation pattern in a predetermined region of the main RAM 70.

The stored data indicative of the variation pattern is transmitted, as a signal for driving and controlling the special symbol display device 33 (a special symbol driving/controlling signal), to the lamp controller circuit 76, through the process in step S46 of FIG. 9. On receiving the special symbol driving/controlling signal, the lamp controller circuit 76 controls the display on the special symbol display device 33, on the basis of the special symbol driving/controlling signal. Through the aforementioned process, the special symbol is variably displayed on the special symbol display device 33 and, after the elapse of a predetermined time, the special symbol is statically displayed thereon.

Further, the data indicative of this variation pattern is transmitted, as a variation pattern designation command, from the main CPU 66 in the main control circuit 60 to the sub CPU 206 in the sub control circuit 200, through the process in step S47 in FIG. 9. The sub CPU 206 in the sub control circuit 200 performs effect displaying according to the received variation pattern designation command. After the completion of this process, the subroutine proceeds to the process in step S110.

In step S110, a process for setting the waiting time timer to a variable time according to the determined variation pattern is conducted. In this process, the main CPU 66 reads a variable time according to the variation pattern determined through the process in step S109 from a table and stores a value indicative of the variable time in the waiting time timer. Then, the main CPU 66 conducts a process for clearing the storage region which stores the big-hit determination random number used for the current variable display and the like (step S111). After the completion of this process, this subroutine ends.

FIG. 14 is a flowchart illustrating the subroutine of the input detection process which is called up and conducted in step S43 in the process illustrated in FIG. 9.

First, as illustrated in FIG. 14, the main CPU 66 conducts a winning ball-related switch check process (step S231). In this process, the main CPU 66 detects whether or not predetermined detection signals have been transmitted from the various types of sensors relating to ball disbursement, such as the V-counting sensor 102, the counting sensor 104, the regular winning ball sensors 106, 108, 110 and 112, the starting winning ball sensor 116 and the like. Then, after conducting the detecting processes for such predetermined signals, the main CPU 66 determines the number of balls to be disbursed on the basis of the sensor which transmitted a signal and stores it in the main RAM 70. After the completion of this process, the subroutine proceeds to the process in step S232.

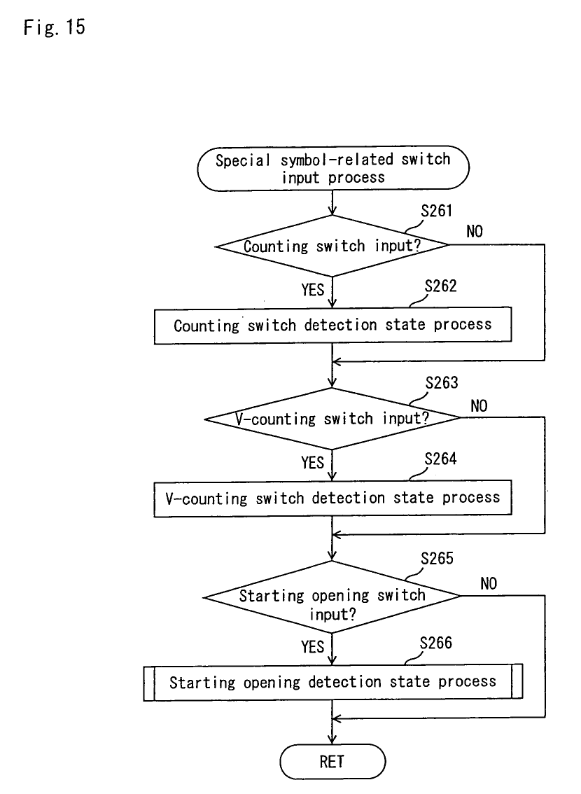

In step S232, special symbol relating switch input process is conducted. As will be described in detail later with reference to FIG. 15, the main CPU 66 determines whether or not a predetermined signal has been transmitted from the V-counting sensor 102, the counting sensor 104 or the starting winning ball sensor 116 which relates to special symbols. After executing the detection process for such predetermined signals, the main CPU 66 conducts a process which will be described later. After the completion of this process, the subroutine proceeds to the process in step S233.

In step S233, a normal symbol-related switch input process is conducted. In this process, the passed-ball sensor 114 transmits a predetermined detection signal to the main CPU 66. On receiving the predetermined detection signal, the main CPU 66 conducts a process such as a normal symbol starting storage process and the like. After the completion of this process, this subroutine ends.

FIG. 15 is a flowchart illustrating the subroutine of the special symbol-related switch input process which is called up and conducted in step S232 in the subroutine illustrated in FIG. 14.

First, as illustrated in FIG. 15, it is determined whether or not there is a counting switch input (step S261). In this process, if the main CPU 66 determines that there is a counting switch input, on the basis of a predetermined signal transmitted from the counting sensor 104, the main CPU 66 conducts a counting switch detection process for updating the special winning opening entry counter such that the stored value is incremented by “1” (step S262). On the other hand, if the main CPU 66 determines that there is no counting switch input, the subroutine proceeds to the process in step S263.

In step S263, it is determined whether or not there is a V-counting switch input. In this process, if the main CPU 66 determines that there is a V-counting switch input, on the basis of a predetermined signal transmitted from the V-counting sensor 102, the main CPU 66 conducts a V-counting switch detection process for setting a flag indicating that gaming balls have passed through the specific region and for updating the special winning opening entry counter such that the stored value is incremented by “1” (step S264). On the other hand, if the main CPU 66 determines that there is no V-counting switch input, the subroutine proceeds to the process in step S265.

In step S265, it is determined whether or not there is a starting opening switch input. In this process, the main CPU 66 determines whether or not there is a starting opening switch input, by receiving a predetermined signal from the starting winning ball sensor 116. If the main CPU 66 determines that there is a starting opening switch input, the subroutine proceeds to the process in step S266, and if it does not determine there is a starting opening switch input, this subroutine ends.

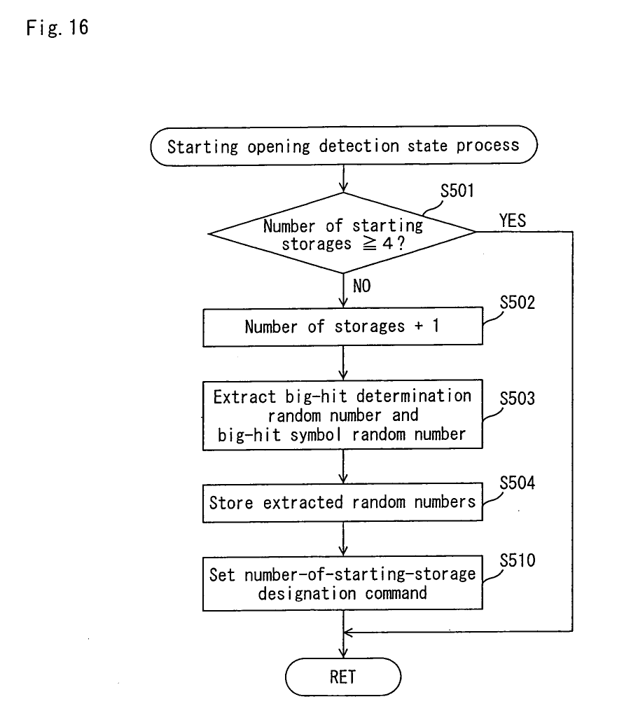

In step S266, a starting opening detection process is conducted and, after the completion of this process, this subroutine ends. As will be described in detail later with reference to FIG. 16, if the main CPU 66 determines that the data indicative of the number of holds is smaller than “4”, the main CPU 66 extracts a big-hit determination random number and a big-hit symbol random number and stores them in a predetermined region of the main RAM 70. After the completion of this process, this subroutine ends.

FIG. 16 is a flowchart illustrating the subroutine of the starting opening detection process which is called up and conducted in step S266 in the subroutine illustrated in FIG. 15.

First, as illustrated in FIG. 16, the main CPU 66 reads the number of starting storages (so-called “data indicative of the number of holds” as previously described) from a number-of-starting-storages counter and determines whether or not the number of starting storage is equal to or greater than “4” (step S501). In this process, if the main CPU 66 determines that the number of starting storages is equal to or greater than “4”, the subroutine ends. Namely, if the number of holds reaches an upper limit value, the subroutine ends, without storing starting storage information, even when a gaming ball has entered the starting opening 44. On the other hand, if the main CPU 66 determines that the number of starting storages is smaller than “4”, the number-of-starting-storages counter is incremented by “1” (step S502) and the subroutine proceeds to the process in step S503.

In step S503, the main CPU 66 extracts a big-hit determination random number from the big-hit determination random number counter and extracts a big-hit symbol random number from the big-hit symbol determination random number counter. Then, the main CPU 66 stores the extracted big-hit determination random number and the big-hit symbol random number as starting storage information in a predetermined region of the main RAM 70 (step S504). The main CPU 66 reads data indicative of the stored big-hit determination random number and the stored big-hit symbol random number, in the process in step S105 and the like in FIG. 12, then determines whether or not a big hit occurs and determines the type of a special symbol to be statically displayed. As described above, in the event that a predetermined variable display holding condition is satisfied even when gaming balls have entered the starting opening 44, the main CPU 66 stores the starting storage information used for determining the result of variable display of special symbols up to a predetermined number as an upper limit, until a predetermined variable display starting condition which enables variable display of special symbols is satisfied. After the completion of this process, the subroutine proceeds to the process in step S510.

In step S510, the main CPU 66 reads the data indicative of the number of starting storages and sets data indicative of the number-of-starting-storages designation command based on the data indicative of the number of starting storages, in a predetermined region of the main RAM 70. The data indicative of the number-of-starting-storage designation command which has been set as aforementioned is transmitted to the sub CPU 206 in the sub control circuit 200 from the main CPU 66 in the main control circuit 60, through the process in step S47 in FIG. 8. The sub CPU 206 of the sub control circuit 200 performs effects and notification relating to the number of starting storages, on the basis of the received

number-of-starting-storage designation command, as will be described later. The number-of-starting-storage command includes data based on the big-hit determination random number and the big-hit symbol random number which have been extracted in step S503 (for example, whether or not the random number is a random number which causes transition to a special game state, the result of variable display of special symbols and the like), and the number-of-starting-storage command is transmitted from the main control circuit 60 to the sub control circuit 200 so that the sub control circuit 200 (the sub CPU 206) can recognize whether or not the random number is a random number which causes the transition to a special game state, the result of variable display of special symbols and the like. After the completion of this process, this subroutine ends.

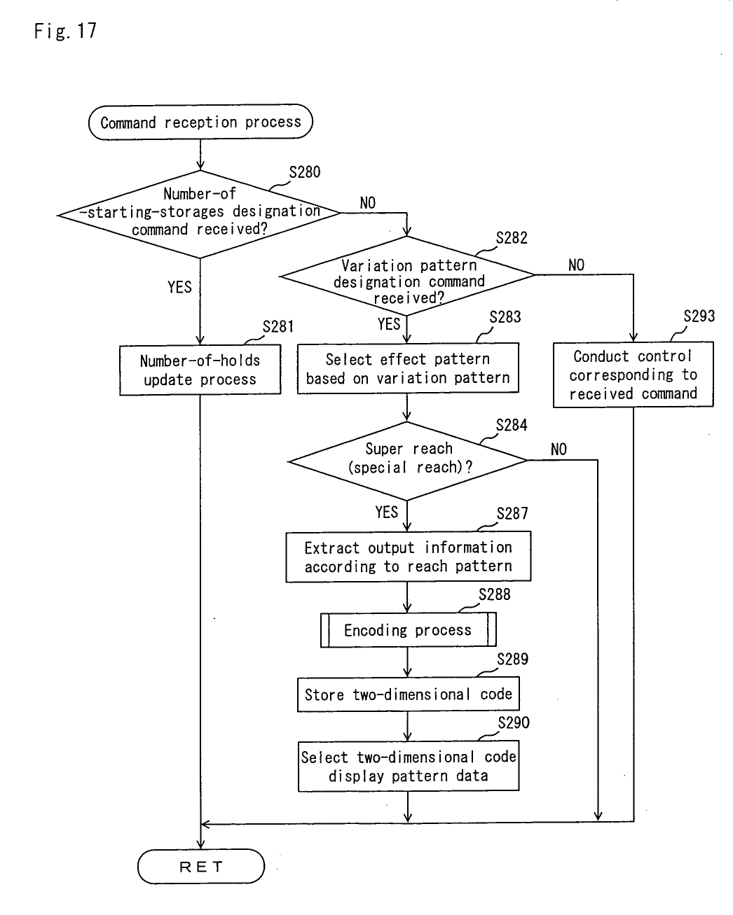

On the other hand, the sub control circuit 200 receives various types of commands transmitted from the main control circuit 60 and conducts a command reception process as illustrated in FIG. 17.

First, as illustrated in FIG. 17, the sub CPU 206 determines whether or not it has received a number-of-starting-storages designation command (step S280). In this process, if the sub CPU 206 determines that it has received a number-of-starting-storages designation command from the main control circuit 60, the subroutine proceeds to the process in step S281. On the other hand, if the sub CPU 206 does not determine that it has received a number-of-starting-storages designation command from the main control circuit 60, the subroutine proceeds to the process in step S282.

In step S281, the sub CPU 206 conducts a number-of-holds update process. In this process, the sub CPU 206 sets starting storage information, data indicative of the number of starting storages before the updating and data indicative of the updated number of starting storages, in a predetermined region of the work RAM 210. Then, the sub CPU 206 determines the number of starting storages on the basis of the

number-of-starting-storages designation command received from the main control circuit 60 and updates the data indicative of the number of starting storages positioned in the predetermined region of the work RAM 210. Further, in this process, the updating is performed, regardless of whether the number of holds is increased or decreased. After the completion of this process, this subroutine ends.

On the other hand, in step S282, the sub CPU 206 determines whether or not it has received a variation pattern designation command. In this process, if the sub CPU 206 determines that it has received a variation pattern designation command from the main control circuit 60, the subroutine proceeds to the process in step S283. On the other hand, if the sub CPU 206 does not determine that it has received a variation pattern designation command from the main control circuit 60, the subroutine proceeds to the process in step S293.

In step S283, the sub CPU 206 determines an effect pattern, on the basis of the received variation pattern designation command. For example, in the case where the variation pattern designation command indicates a normal reach, the sub CPU 206 determines an effect pattern corresponding to the normal reach and, in the case where the variation pattern designation command indicates a super reach, it determines an effect pattern corresponding to the super reach. Consequently, an effect based on the determined effect pattern is executed. After the completion of this process, the subroutine proceeds to the process in step S284.

In step S284, the sub CPU 206 determines whether or not the variation pattern designation command indicates a super reach. In this process, if the sub CPU 206 determines that the variation pattern designation command indicates a super reach, the subroutine proceeds to the process in step S287. On the other hand, if the sub CPU 206 does not determines that the variation pattern designation command indicates a super reach, the subroutine ends.

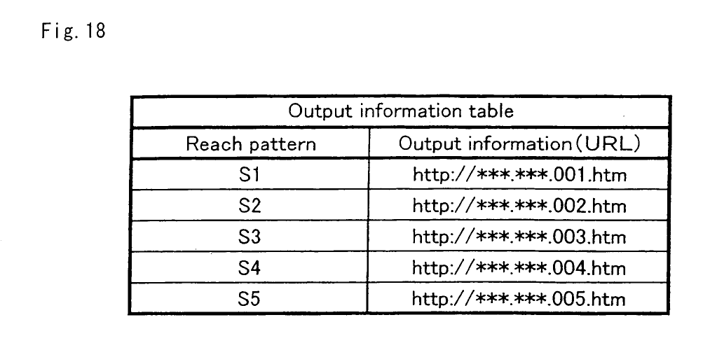

In step S287, the sub CPU 206 refers to an output information table (see FIG. 18) and extracts output information according to the reach pattern.

FIG. 18 is a view illustrating an exemplary output information table.

In the output information table, as illustrated in FIG. 18, reach patterns (see FIG. 13) are associated with output information (URLs).

After the completion of this process, the sub CPU 206 proceeds to the process in step S288.

In step S288, the sub CPU 206 encodes the output information generated in step S287 into a two-dimensional code. The encoding process will be described later. After the completion of this process, the sub CPU 206 proceeds to the process in step S289.

In step S289, the sub CPU 206 stores the two-dimensional code generated in step S288 in the work RAM 210. After the completion of this process, the sub CPU 206 proceeds to the process in step S290.

In step S290, the sub CPU 206 reads a two-dimensional code display pattern data from the program ROM 208 and transmits it to the display control circuit 250. Thereafter, the subroutine ends.

In step S282, if the sub CPU 206 determines that it has not received a variation pattern designation command, it conducts a process according to received commands in step 293 and, thereafter, the subroutine ends.

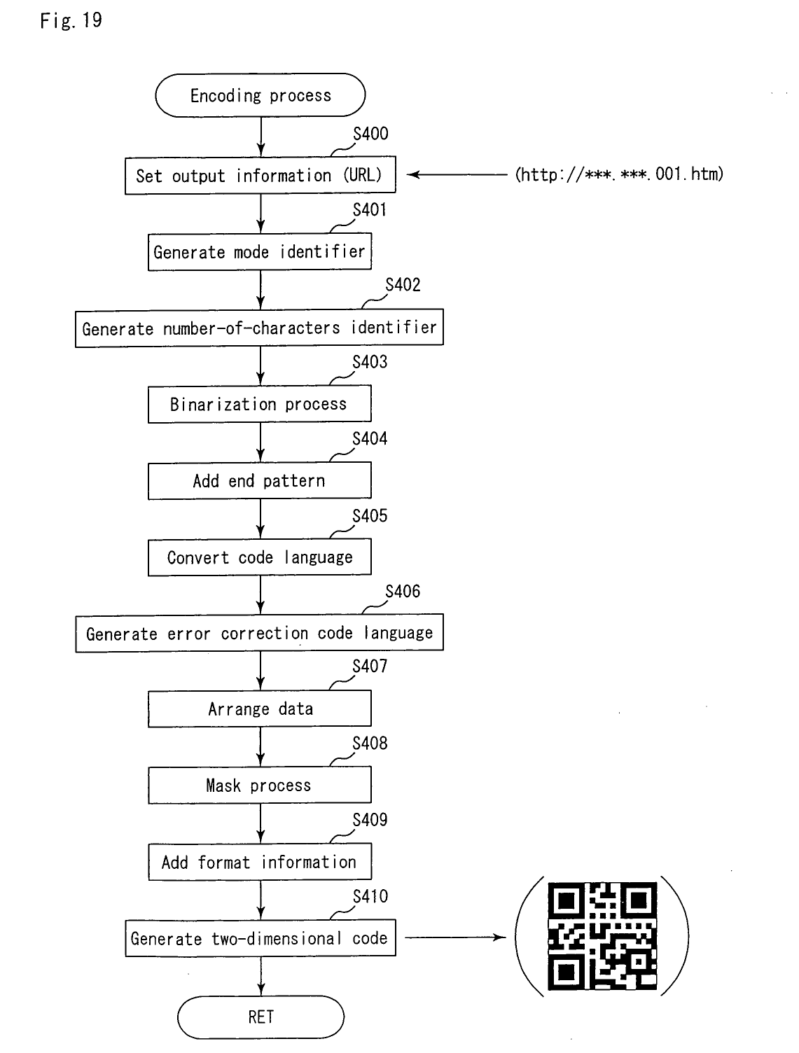

FIG. 19 is a flowchart illustrating the subroutine of the encoding process which is called up and conducted in step S287 in the subroutine illustrated in FIG. 17.

First, the sub CPU 206 sets the output information (URL) stored in the program ROM 208 in the work RAM 210 (step S400).

In the figure, there is illustrated

“http://***.***. 001.htm” as an example of output information.

Next, the sub CPU 206 generates a mode identifier corresponding to the type of characters of the output information (for example, numerical characters, alphanumeric characters, Chinese characters), in the work RAM 210 (step S401).

Next, the sub CPU 206 generates a number-of-characters identifier according to the number of characters of the output information, in the work RAM 210 (step S402).

Next, the sub CPU 206 conducts a process for binarizing the output information (step S403). Next, the sub CPU 206 conducts a process for adding an end pattern to the data obtained from steps S401 to S403 (step S404).

Next, the sub CPU 206 conducts code language conversion on the data obtained in step S404 (step S405), then generates an error correction code language on the basis of the data obtained in step S405 and adds it to the data obtained in step S405 (step S406). Next, the sub CPU 206 conducts a process for binarizing the data obtained in step S406 and arranging it in a matrix shape (step S407).

Next, the sub CPU 206 conducts a process for masking the data obtained in step S407 with a predetermined pattern (step S408). Next, it conducts a process for adding format information including an error correction level and a mask identifier (step S409) and generates a two-dimensional code (step S410). The generated two-dimensional code is stored in the work RAM 210. Thereafter, this subroutine ends.

While, in the present embodiment, there has been described a case where only an URL as output information is encoded (coded) into a two-dimensional code, output information and other data (for example, data indicative of the machine model of the gaming machine, data uniquely allotted for the gaming machine for identification of the gaming machine itself or the like) may be encoded in the present invention.

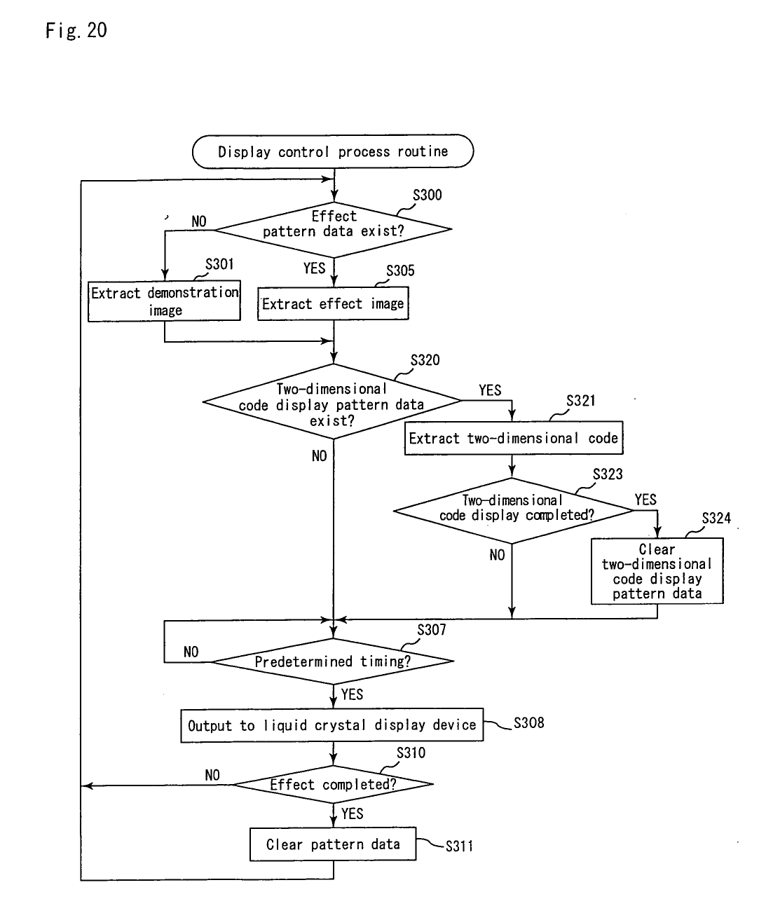

FIG. 20 is a flowchart illustrating the subroutine of the display control process conducted in the display control circuit.

The VDP 212 generates a screen image according to various types of data transmitted from the sub CPU 206.

When the VDP 212 has received no effect pattern data from the sub CPU 206 (step S300: NO), it extracts a demonstration image from the image data ROM 216, on the basis of a demonstration display command, and stores it in the buffer (step S301).

When the VDP 212 has received an effect pattern data from the sub CPU 206 (step S300: YES), it extracts an effect image from the image data ROM 216, on the basis of the effect pattern data, and stores it in the buffer (step S305). The effect image includes effect identification information images representing the aforementioned effect identification information.

After conducting the process in step S301 or the step S305, if the VDP 212 has received a two-dimensional code display pattern data (step S320: YES), it extracts a two-dimensional code from the work RAM 210 and stores it in the buffer (step S321). At this time, the two-dimensional code is stored such that it is superimposed on the effect image which has been extracted and stored in the buffer in step S301 or the step S305.

Thereafter, when the timing of completion of displaying of the two-dimensional code comes (step S323: YES), the two-dimensional code display pattern data is cleared (step S324).

Then, at every predetermined timing (for example, at every 1/30-seconds) (step S307: YES), the screen image is output to the liquid crystal display device 32 (step S308). As a result, a two-dimensional code 92 is displayed on the liquid crystal display device 32, as illustrated in FIG. 6.

On the other hand, when the predetermined timing has not come (step S307: NO), the subroutine returns to the process in step S307.

Thereafter, when the effect has not been completed (step S310: NO), the subroutine returns to the process in step S300. On the other hand, if the effect has been completed (step S310: YES), the effect pattern data is cleared (step S311) and the subroutine returns to the process in step S300.

FIG. 21 is a block diagram illustrating the internal structure of the portable telephone illustrated in FIG. 1.

The portable telephone 400 corresponds to the portable terminal device according to the present invention.

The portable telephone 400 includes an operating portion 404, a liquid crystal display panel 406, a CCD camera 408 as an image pickup means, a wireless communication portion 410, a sound circuit 412, a speaker 414, a microphone 416, a transmission/reception antenna 418, a nonvolatile memory 420, a microcomputer 422 and a secondary battery 424.

The wireless communication portion 410 performs transmission and reception to and from a base station, by using radio waves as media, through the transmission/reception antenna 418, under the control of the microcomputer 422. The sound circuit 412 outputs, to the speaker 414, reception signals output from the wireless communication portion 410 through the microcomputer 422 and also outputs sound signals output from the microphone 416, as sound signals, to the wireless portion 410 through the microcomputer 422.

The speaker 414 converts the reception signals output from the sound circuit 412 into reception sounds and outputs them, and the microphone 416 converts transmission sounds generated by an operator into sound signals and outputs them to the sound circuit 412.

The CCD camera 408 is capable of capturing the two-dimensional code 92 displayed on the liquid crystal display device 32 of the pachinko gaming machine 10 and the image data resulted from the capturing it is stored in the nonvolatile memory 420. While, in the present embodiment, there will be described a case where the CCD camera is employed as the image pickup means, the image pickup means is not particularly limited and may be, for example, a CMOS sensor camera, in the present invention.

The nonvolatile memory 420 stores, in a nonvolatile manner, various types of data, such as image data generated by capturing the two-dimensional code 92 with the CCD camera 408, image data for waiting images, sound data for cellular phone ring melodies, and various types of programs.

The secondary battery 424 supplies electric power to the respective circuits. The microcomputer 422 is constituted by a CPU, a ROM and a RAM and conducts, for example, a phone sending/receiving processing, e-mail

generating/sending/receiving processing, Internet processing and the like. The transmission/reception of e-mails and the transmission/reception of data via the Internet are performed by the microcomputer 422, through the wireless communication portion 410 and the transmission/reception antenna 418.

The microcomputer 422 downloads predetermined programs from the server 600 via the Internet, on the basis of a predetermined command input through the operating portion 404 and stores them in the nonvolatile memory 420. Then, the microcomputer 422 reads the aforementioned program from the nonvolatile memory 420 and executes them to provide the following functions (A) to (B).

(A) The microcomputer 422 recognizes a two-dimensional code from image data generated by capturing the two-dimensional code 92 with the CCD camera 408 and generates output information from the recognized two-dimensional code.

(B) The microcomputer 422 transmits the output information generated as in the aforementioned (A) to the server 600, via the Internet, through the wireless communication portion 410 and the transmission/reception antenna 418.

While, in the present embodiment, there will be described a case where the portable telephone 400 downloads programs from the server 600, such programs may be previously stored (preinstalled) in the nonvolatile memory 420 of the portable telephone 400.

FIG. 22 is a block diagram illustrating the internal structure of the server illustrated in FIG. 1

The server 600 includes a CPU 601 as a calculation processing device, a ROM 602, a RAM 603, a communication interface circuit 604 for communication with the portable telephone 400 via the Internet, and a hard disk drive 605.

The hard disk drive 605 stores plural types of premium data, for example, image data for waiting images representing characters appearing in effects in the pachinko gaming machine 10, music data for cellular phone ring melodies which are made of BGMs in the pachinko gaming machine 10 and the like. The premium data is not limited to these examples and may be, for example, information about games. Further, the hard disk drive 605 stores a premium data table.

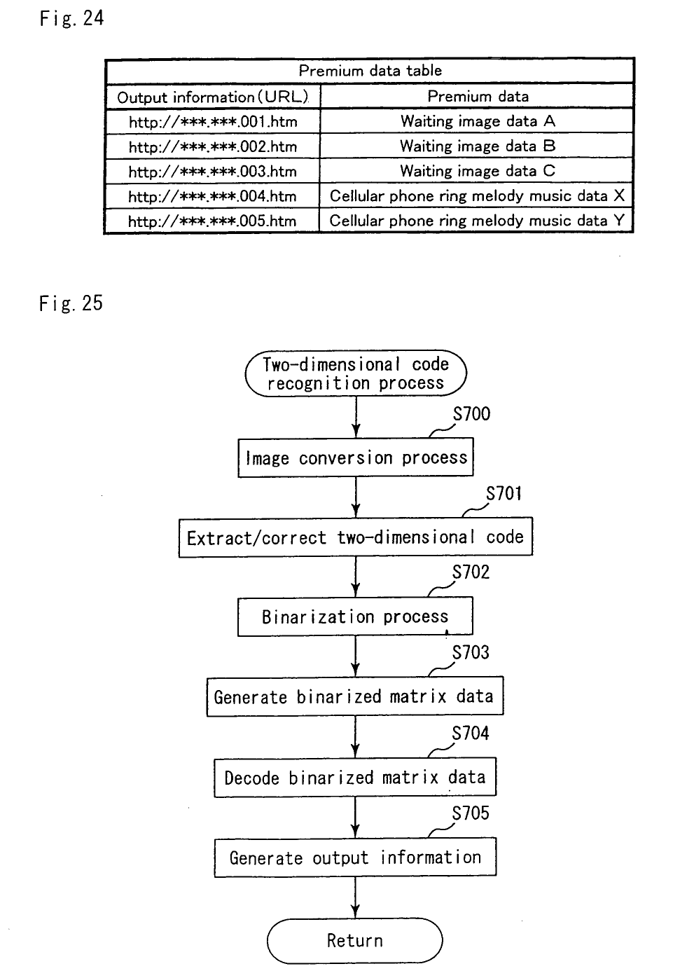

On receiving the output information and the ID data of the portable telephone 400 from the portable telephone 400, the CPU 601 refers to the premium data table (see FIG. 24) stored in the hard disk drive 605, on the basis of the aforementioned output information, and selects premium data associated with the aforementioned output information. Next, the CPU 601 extracts the selected premium data, from plural types of premium data stored in the hard disk drive 605. Then, the CPU 601 transmits the premium data extracted from the hard disk drive 605, to the portable telephone 400, via the Internet.

Further, the hard disk drive 605 stores programs to be downloaded to the portable telephone 400. On receiving a request signal for downloading a program thereto from the portable telephone 400, the CPU 601 reads the program from the hard disk drive 605 and transmits the program to the portable telephone 400 through the communication interface circuit 604 via the Internet.

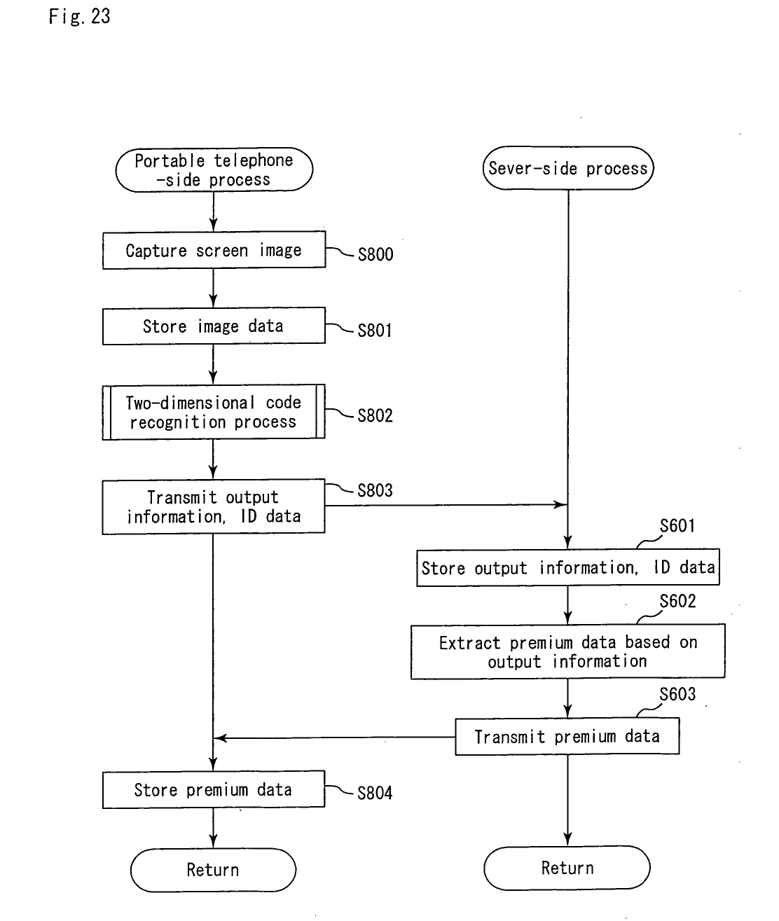

FIG. 23 is a flowchart illustrating a process conducted by the portable telephone and the server.

First, the microcomputer 422 included in the portable telephone 400 drives the CCD camera 408 as an image pickup means, on the basis of a command input through the operating portion 404, and the CCD camera 408 captures a two-dimensional code 92 included in a screen image displayed on the liquid crystal display device 32 of the pachinko gaming machine 10 (step S800).

Then, the microcomputer 422 stores the image data obtained in step S800 in the nonvolatile memory 420 (step S801).

Then, the microcomputer 422 conducts two-dimensional code recognition process (step S802) to recognize the two-dimensional code from the image data obtained in step S800 and generates output information from the recognized two-dimensional code. The two-dimensional code recognition process will be described in detail later.

Next, the microcomputer 422 transmits the output information resulted from the two-dimensional code recognition process in step S802 along with the ID data of the portable telephone 400, to the server 600, through the wireless communication portion 410 and the transmission/reception antenna 418, via the Internet (step S803).

On receiving the output information and the ID data of the portable telephone 400, via the Internet from the portable telephone 400, the CPU 601 included in the server 600 stores the output information and the ID data in the hard disk drive 605 (step S601).

Then, on the basis of the output information, the CPU 601 refers to the premium data table (see FIG. 24) stored in the hard disk drive 605 and extracts, from the hard disk drive 605, premium data corresponding to the output information (step S602).

FIG. 24 is an exemplary premium data table.

In the premium data table, as illustrated in FIG. 24, output information and premium data are associated with each other.

Next, the CPU 601 transmits the premium data extracted in step S602 to the portable telephone 400 (step S605). At this time the CPU 601 functions as a transmission means for transmitting the premium data extracted in step S602 to the portable telephone 400.

The microcomputer 422 in the portable telephone 400 stores the premium data transmitted from the server 600 in the nonvolatile memory 420 (step S804). As a result, the player can acquire the premium data.

FIG. 25 is a flowchart illustrating the two-dimensional code recognition process which is called up and conducted in step S801 in the process illustrated in FIG. 23.

First, the microcomputer 422 conducts an image conversion process on the image data stored in the nonvolatile memory 420 (step S700). The image converting process is a process for extracting image data of the region in which a two-dimensional code is displayed, from image data generated by capturing a two-dimensional code, then performing corrections of the inclination and the distortion thereon and converting the image data into a monochrome image with a predetermined threshold value to generate image data including a frontward-faced two-dimensional code.

Next, the microcomputer 422 extracts the two-dimensional code from the image data obtained in step S700 and performs corrections such as noise elimination (step S701).

Next, the microcomputer 422 conducts a binarization process on the two-dimensional code obtained in step S701 to substitute “0” or “1” for the respective dots constituting the two-dimensional code (step S702) and then generates binarized matrix data (step S703).

Next, the microcomputer 422 decodes the binarized matrix data (step S704) and generates output information (step S705). Subsequently, this subroutine ends and the process proceeds to step S803 in the flowchart illustrated in FIG. 23.

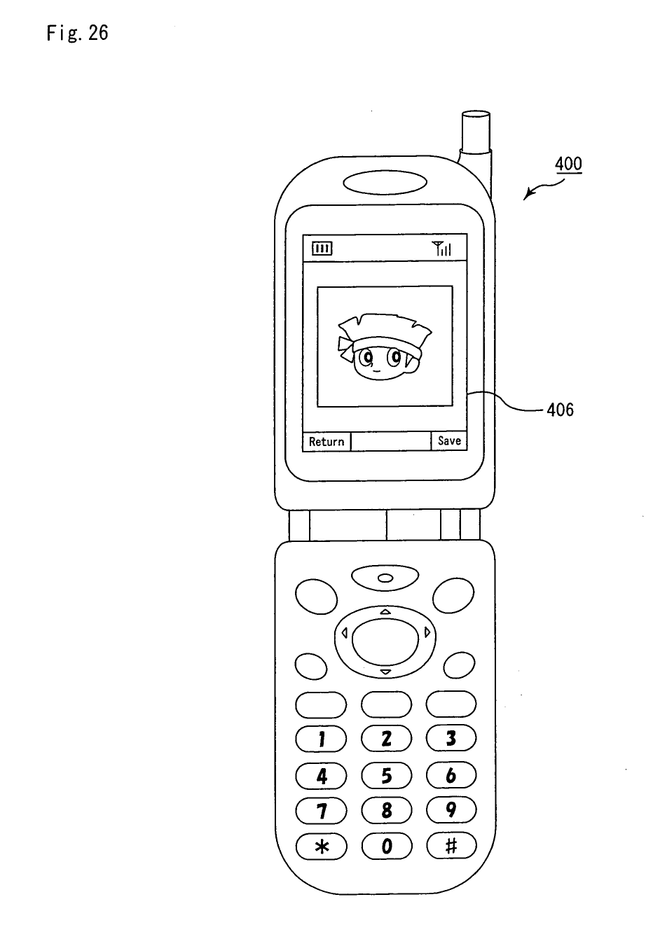

As described above, when the portable telephone 400 transmits the output information and the ID data of the portable telephone 400 to the server 600 (FIG. 23, step S803), the premium data corresponding to the output information is transmitted to the portable telephone 400 (FIG. 23, step S605) and the premium data is stored in the nonvolatile memory 420 included in the portable telephone 400. As a result, for example, an image as illustrated in FIG. 26 is displayed on the liquid crystal display panel 406 included in the portable telephone 400.

FIG. 26 is a view illustrating an exemplary image being displayed on the liquid crystal display panel 406 of the portable telephone 400. This image is a waiting image obtained by capturing a two-dimensional code 92 through the portable telephone 400 and transmitting output information, which is generated from the resultant image data in the portable telephone 400, to the server 600.

As described above, in the present embodiment, in the pachinko gaming machine 10, a specific reach image is displayed during super reach and, on the occasion where the specific reach image is displayed, a two-dimensional code 92 is displayed, and the player can transmit, to the server 600, output information (URL) generated from the two-dimensional code 92 through the CCD camera 408 in the portable telephone 400 to acquire premium data associated with the output information, such as image data for a waiting image, music data for a cellular phone ring melody and the like. As described above, with the present embodiment, output information can be acquired when a specific reach image is displayed. Therefore, for example, when only reaches frequently occur and no big hit occurs and, as a result, the special game state can not occur for a long time, if a two-dimensional code 92 is displayed, this can cast aside the player's dissatisfaction and uncomfortable feeling.

In the present invention, it is preferable that such a two-dimensional code is included in a specific reach image. Since a two-dimensional code is displayed along with a specific reach image, the player can immediately acquire output information, in the event that the specific reach image is displayed, which can immediately offer satisfaction to the player. Also, as in the present embodiment, a two-dimensional code may be displayed on the occasion when the specific reach image is displayed.

Further, in the present invention, it is preferable that there are plural types of specific reach images and the respective specific reach images are associated with different output information. Even when only reach frequently occurs and the special game state does not occur for a long time, the player can acquire a greater amount of output information, which can cast aside the player's dissatisfaction and uncomfortable feeling.

In the present invention, an output information image can include time-limited information. Namely, the gaming machine can display a two-dimensional code which is created by coding data indicative of output information and the current time and date. Further, on receiving or generating output information based on a two-dimensional code and data indicative of the time and date of the current, the server determines whether or not a predetermined time (for example, one day, one week and the like) has elapsed, on the basis of the time and date of reception or generation of these data and the time and date when the output information was coded into the two-dimensional code. If the server determines that a predetermined time has elapsed, it does not transmit premium data to the portable telephone and may transmit, thereto, data for displaying an image indicative of expiration of limitation period on the portable telephone.

Further, in the present invention, the gaming machine may display a two-dimensional code which is generated by coding data indicative of output information and the current time and date. Further, on receiving or generating output information based on a two-dimensional code and data indicative of the time and date of the current, the server determines whether or not it has received output information associated with the two-dimensional code which was displayed at the same time, on the basis of the output information, the data indicative of the time and date of the current time and the ID data of the portable telephone. Preferably, if the server determines that it has received output information associated with the two-dimensional code which was displayed at the same time, it does not transmit premium data to the portable telephone. This can prevent premium data from being acquired unrighteously by transmitting output information which was generated by capturing a two-dimensional code only a single time to the server plural times

Further, the effects described in the embodiments of the present invention are only most preferred effects of the present invention, and the effects of the present invention are not limited to those described in the embodiments of the present invention.

What is claimed as new and desired to be secured by Letters Patent of the United States is:

1. A gaming machine comprising:
display means capable of displaying images;
storage means for storing plural types of reach effect images to be displayed during reach, as image data representing images to be displayed on said display means; and
display control means for displaying reach effect images on said display means, on the basis of image data selected from the image data stored in said storage means,
wherein
said display control means, on the occasion of display of specific reach effect images on the basis of image data having a lower probability of being selected out of the plural types of image data stored in said storage means, displays an output information image including predetermined output information on said display means, in such a manner that the output information image can be captured from the outside by image pickup means.

2. The gaming machine according to claim 1,
wherein
said output information image is included in a specific reach image.

3. A service providing system comprising:
the gaming machine according to claim 1; and
a server capable of transmitting and receiving data to and from a portable terminal device including said image pickup means through a communication line,
wherein
said server includes:
information storage means for storing plural types of information to be transmitted to said portable terminal device, in association with respective output information;
extraction means for extracting information associated with output information from said information storage means, on receiving this output information from the portable terminal device which generates the output information on the basis of image data resulted from capturing of an output information image displayed on said display means with said image pickup means; and
transmission means for transmitting the information extracted by said extraction means to said portable terminal device, through said communication line.

4. A server capable of transmitting and receiving data to and from a portable terminal device including image pickup means capable of capturing output information images displayed on the display means included in the gaming machine according to claim 1, through a communication line,
said server comprising:
information storage means for storing plural types of information to be transmitted to said portable terminal device, in association with respective output information;
extraction means for extracting information associated with output information from said information storage means, on receiving this output information from the portable terminal device which generates the output information on the basis of image data resulted from capturing of an output information image displayed on said display means with said image pickup means; and
transmission means for transmitting the information extracted by said extraction means to said portable terminal device, through said communication line.
